(19) United States
(12) Patent Application Publication
(10) Pub. No.: US 2025/0080826 A1
(43) Pub. Date: Mar. 6, 2025

(54) PHOTOELECTRIC CONVERSION DEVICE, MOVABLE APPARATUS, CONTROL METHOD, AND STORAGE MEDIUM

(71) Applicant: CANON KABUSHIKI KAISHA, Tokyo (JP)

(72) Inventors: Yuya KURATA, Tochigi (JP); Masatsugu NAKANO, Tochigi (JP); Ikunari NOBORIKAWA, Tochigi (JP)

(21) Appl. No.: 18/814,736

(22) Filed: Aug. 26, 2024

(30) Foreign Application Priority Data
Aug. 30, 2023 (JP) 2023-139711

(51) Int. Cl. H04N 23/61; H04N 23/55; H04N 25/773

(52) U.S. Cl. CPC H04N 23/61; H04N 23/55; H04N 25/773

(57) ABSTRACT

In a photoelectric conversion device, pixels each including a photoelectric conversion unit configured to emit pulses in response to photons, a counter configured to count the number of the pulses, and a memory configured to store a count value of the counter, an optical system configured to form an object image having different resolutions in a first pixel region and a second pixel region of a sensor unit, a signal is generated based on a difference between count values of the counter, control is performed such that a signal generated in a first accumulation period is output between the end of the first accumulation period and the end of a second accumulation period, and control is performed such that an accumulation period of the first pixel region and an accumulation period of the second pixel region is set to the first accumulation period and the second accumulation period.

### BACKGROUND OF THE INVENTION

### Field of the Invention

The present invention relates to a photoelectric conversion device, a movable apparatus, a control method, and a storage medium.

### Description of the Related Art

In recent years, a photoelectric conversion device has been developed in which the number of photons incident on an avalanche photodiode (APD) is digitally counted, and the counting value is output from a pixel as a digital signal obtained by photoelectric conversion.

Additionally, for example, in Japanese Patent No. 7,223,070, a configuration is described in which, in a photoelectric conversion device having an APD, a plurality of videos whose accumulation periods overlap with each other can be output and continuous photographing can be performed even at low illuminance. Additionally, Japanese Patent Laid-Open No. 2021-34786 discloses a configuration in which signals are read out from pixel regions in which a moving object is detected at a high frame rate.

However, for example, in the case of assuming an imaging element of a camera, since recognition processing is performed in frame units in normal driving of a sensor unit, the recognition processing can be executed only every 33.3 ms in a case where the frame rate is, for example, 30 fps (frames/second). Therefore, in a normal camera, even if an object appears immediately after frame switching, the recognition processing cannot be performed until the end of the frame.

In contrast, in a monitoring system using, for example, an in-vehicle camera, it is required to accurately and quickly recognize a vehicle, a person, and the like that suddenly appears from a region that is a blind spot of the driver so that the risk of collision and the like are reduced.

### SUMMARY OF THE INVENTION

Therefore, the in-vehicle camera is required to be capable of acquiring and recognizing an image in a short time with high resolution. However, there is a drawback in that an amount of data increases and power consumption increases when image capture is performed at a high resolution and a short frame rate.

A photoelectric conversion device according to an aspect of the present invention comprising: a plurality of pixels each including a photoelectric conversion unit configured to emit pulses in response to photons, a counter configured to count the number of the pulses, and a memory configured to store a count value of the counter; an optical system configured to form an object image having different resolutions in a first pixel region and a second pixel region of a sensor unit consisting of the plurality of pixels; one or more memories storing instructions; and one or more processors executing the instructions to: generate a signal based on a difference between count values of the counter at a start time and an end time of an accumulation period; perform control such that a signal generated in a first accumulation period is output between the end of the first accumulation period and the end of a second accumulation period, the first accumulation period and a second accumulation period longer than the first accumulation period being included in one full frame period; and perform control such that an accumulation period of the first pixel region is set to the first accumulation period and an accumulation period of the second pixel region is set to the second accumulation period, or that an accumulation period of the first pixel region is set to the second accumulation period and an accumulation period of the second pixel region is set to the first accumulation period.

Further features of the present invention will become apparent from the following description of embodiments with reference to the attached drawings.

### BRIEF DESCRIPTION OF THE DRAWINGS

FIG. 1 is a diagram showing a configuration example of a sensor unit 100 according to the first embodiment.

FIG. 2 is a diagram showing an example of a configuration of a sensor unit substrate 11 according to the first embodiment.

FIG. 3 is a diagram showing an example of a configuration of a circuit substrate 21 according to the first embodiment.

FIG. 4 is a diagram showing an equivalent circuit of a photoelectric conversion unit 102 and a signal processing circuit 103 corresponding to the photoelectric conversion unit 102 in FIG. 2 and FIG. 3.

FIG. 5 is a diagram schematically showing the relation between the operation of an APD 201 and the output signal.

FIG. 6 is a functional block diagram of a photoelectric conversion device 600 according to the first embodiment.

FIG. 7 is a diagram for explaining a photoelectric conversion method performed by a control unit 605 according to the first embodiment.

FIG. 8 is a diagram showing an example of images of a plurality of divided accumulation periods according to the first embodiment.

FIG. 9 is a diagram illustrating a relation between a memory and a buffer in the first embodiment.

FIG. 10 is a flowchart illustrating details of an example of driving of the sensor unit 100 in the first embodiment.

FIG. 11 is a flowchart continued from FIG. 10.

FIG. 12 is a diagram explaining an example of a mounting position of the photoelectric conversion device 600 according to the first embodiment.

FIG. 13A and FIG. 13B are diagrams that explain optical characteristics of an optical system 601 according to the first embodiment.

FIG. 14 is a diagram that explains an example of a mounting position of the photoelectric conversion device 600 according to the second embodiment.

FIG. 15A and FIG. 15B are diagrams that explain optical characteristics of the optical system 601 according to the second embodiment.

FIG. 16 is a diagram that explains a setting of a region of interest in the third embodiment.

FIG. 17 is a diagram that explains a setting of a region of interest in the fourth embodiment.

FIG. 18 is a diagram that explains a setting of a region of interest in the fifth embodiment.

FIG. 19 is a diagram that explains a setting of a region of interest in the sixth embodiment.

FIG. 20 is a functional block diagram illustrating an example of a configuration of the photoelectric conversion device 600 and a movable apparatus 700 according to the eleventh embodiment.

FIG. 21 is a flowchart that explains a control method of a movable apparatus according to the eleventh embodiment.

FIG. 22 is a flowchart illustrating details of an example of driving of the sensor unit 100 related to a method of setting a region of interest according to the twelfth embodiment.

FIG. 23 is a flowchart continued from FIG. 22.

FIG. 24 is a diagram showing an example of an image for each of a plurality of accumulation periods and setting a region of interest.

FIG. 25 is a flowchart illustrating details of an example in which the sensor unit 100 is driven by setting an accumulation period in the thirteenth embodiment.

FIG. 26 is a flowchart continued from FIG. 25.

FIG. 27 is a flowchart illustrating an example of operation of the control unit after an image is constituted according to the fourteenth embodiment.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

### First Embodiment

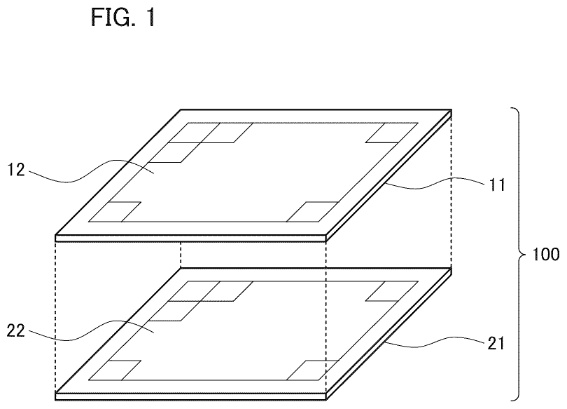

FIG. 1 is a diagram showing a configuration example of a sensor unit 100 according to the first embodiment. Hereinafter, the sensor unit has referred to as a laminated structure in which two substrates of a sensor unit substrate 11 and a circuit substrate 21 are laminated and electrically connected to each other.

However, the sensor unit may have referred to as a non-laminated structure in which a configuration included in the sensor unit substrate 11 and a configuration included in the circuit substrate 21 are arranged in a shared semiconductor layer. The sensor unit substrate 11 includes a pixel region 12. The circuit substrate 21 includes a circuit region 22 in which signals detected in the pixel region 12 are processed.

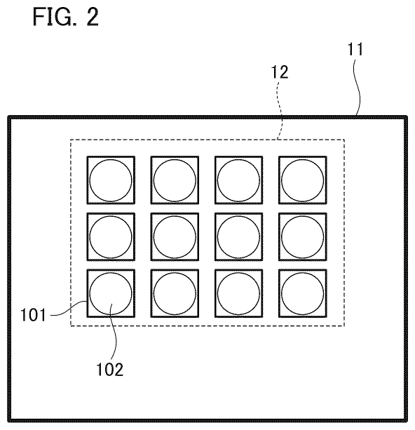

FIG. 2 is a diagram showing a configuration example of the sensor unit substrate 11 according to the first embodiment. The pixel region 12 of the sensor unit substrate 11 includes a plurality of pixels 101 that are two-dimensionally arranged in a plurality of rows and a plurality of columns.

The pixel 101 is provided with the photoelectric conversion unit 102 including an avalanche photodiode (hereinafter, referred to as APD). Here, the photoelectric conversion unit 102 emits a pulse at a frequency corresponding to the frequency of photon reception. That is, the photoelectric conversion unit 102 emits a pulse in response to the incidence of a photon. Note that the number of rows and the number of columns of the pixel array configuring the pixel region 12 are not particularly limited.

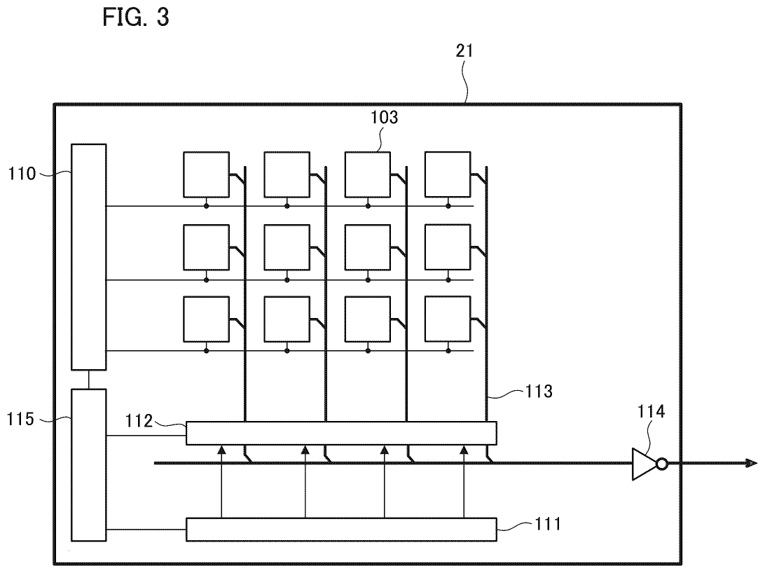

FIG. 3 is a diagram showing a configuration example of the circuit substrate 21 according to the first embodiment. The circuit substrate 21 has a signal processing circuit 103 that processes electric charges that have been photoelectrically converted by the photoelectric conversion units 102 in FIG. 2, a readout circuit 112, a control pulse generation unit 115, a horizontal scanning circuit 111, a vertical signal line 113, a vertical scanning circuit 110, and an output circuit 114.

The vertical scanning circuit 110 receives a control pulse supplied from the control pulse generation unit 115, and sequentially supplies the control pulse to a plurality of pixels arranged in the row direction. The vertical scanning circuit 110 is configured by logic circuits referred to as a shift register and an address decoder.

The signals output from the photoelectric conversion unit 102 of each pixel are processed by each of the signal processing circuits 103. The signal processing circuit 103 is provided with a counter, a memory, and the like, and a digital value is held in the memory. The horizontal scanning circuit 111 inputs a control pulse for sequentially selecting each column to the signal processing circuit 103 in order to read out signals from the memory of each pixel in which a digital signal is held.

The signal is output from the signal processing circuit 103 of the pixel in the row selected by the vertical scanning circuit 110 to the vertical signal line 113. The signal that has been output to the vertical signal line 113 is output to the outside of the sensor unit 100 via the readout circuit 112 and the output circuit 114. The readout circuit 112 incorporates a plurality of buffers connected to each of the vertical signal lines 113.

As shown in FIG. 2 and FIG. 3, a plurality of signal processing circuits 103 are arranged in a region overlapping the pixel region 12 in plan view. The vertical scanning circuit 110, the horizontal scanning circuit 111, the readout circuit 112, the output circuit 114, and the control pulse generation unit 115 are arranged in a region outside the pixel region 12 of the sensor unit substrate 11 so as to overlap each other in plan view.

That is, the sensor unit substrate 11 has the pixel region 12 and a non-pixel region located around the pixel region 12. The vertical scanning circuit 110, the horizontal scanning circuit 111, the readout circuit 112, the output circuit 114, and the control pulse generation unit 115 are arranged in a region overlapping the non-pixel region in a plan view.

Note that the arrangement of the vertical signal lines 113, the arrangement of the readout circuits 112, and the arrangement of the output circuits 114 are not limited to the example as shown in FIG. 3. For example, the vertical signal line 113 may be arranged to extend in the row direction, and the readout circuit 112 may be disposed at the end to which the vertical signal line 113 extends.

Additionally, the signal processing circuit 103 is not necessarily provided in each of all the photoelectric conversion units, and a configuration in which one signal processing circuit is shared for a plurality of photoelectric conversion units and sequential signal processing is performed may be employed.

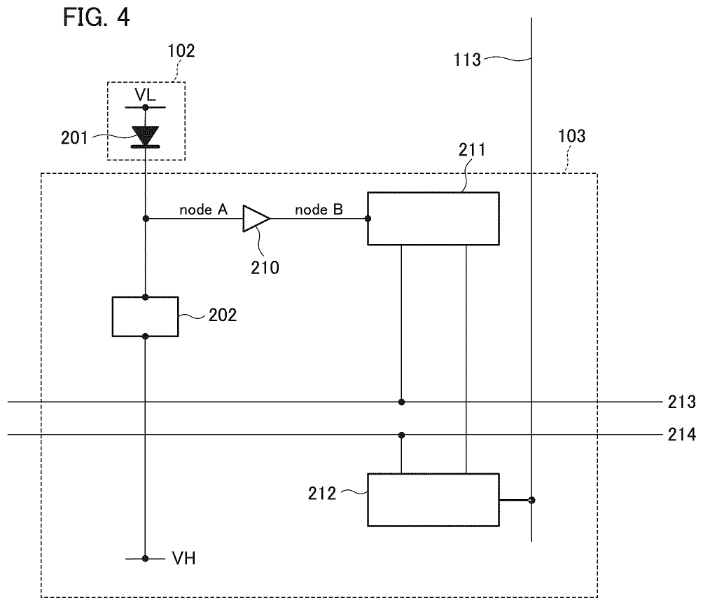

FIG. 4 is a diagram showing an equivalent circuit of the photoelectric conversion unit 102 and the signal processing circuit 103 corresponding to the photoelectric conversion unit 102 in FIG. 2 and FIG. 3. Note that the photoelectric conversion unit 102 and the signal processing circuit 103 are included in each pixel. An APD 201 included in the photoelectric conversion unit 102 generates a charge pair corresponding to incident light by photoelectric conversion.

One of the two nodes of the APD 201 is connected to a power supply line to which a drive voltage VL (first voltage) is supplied. Additionally, the other node of the two nodes of the APD 201 is connected to a power supply line to which a drive voltage VH (second voltage) higher than the voltage VL is supplied via a quench element 202.

In FIG. 4, one node of the APD 201 is an anode, and the other node of the APD is a cathode. A reverse bias voltage is applied to the anode and cathode of the APD 201 so that the APD 201 performs an avalanche multiplication operation. By setting the state in which such a voltage is supplied, the charge generated by the incident light causes avalanche multiplication, and an avalanche current occurs.

Note that, in a case where a reverse bias voltage is supplied, there are a Geiger mode in which the voltage difference between the anode and the cathode is operated at a voltage difference larger than the breakdown voltage, and a linear mode in which the voltage difference between the anode and the cathode is operated at a voltage difference near or below the breakdown voltage. An APD that operates in the Geiger mode is referred to as an SPAD. In the case of the SPAD, for example, the voltage VL (first voltage) is set to −30 V, and the voltage VH (second voltage) is set to 1V.

The signal processing circuit 103 has the quench element 202, a waveform shaping unit 210, a counter 211, and a memory 212. The quench element 202 is connected to a power supply line to which the drive voltage VH is supplied and one node of the anode and the cathode of the APD 201.

The quench element 202 functions as a load circuit (quenching circuit) during signal multiplication due to avalanche multiplication, and has a function of suppressing the voltage supplied to the APD 201 to suppress the avalanche multiplication (quenching operation). Additionally, the quench element 202 has a function of returning the voltage supplied to the APD 201 to the drive voltage VH by flowing an electric current corresponding to the voltage drop in the quench operation (recharge operation).

In FIG. 4, an example in which the signal processing circuit 103 has the waveform shaping unit 210, the counter 211, and the memory 212 in addition to the quench element 202 is shown. The waveform shaping unit 210 shapes a voltage change at the cathode of the APD 201 obtained during photon detection, and outputs a pulse signal.

As the waveform shaping unit 210, for example, an inverter circuit is used. Although, in FIG. 4, an example in which one inverter is used as the waveform shaping unit 210 is shown, a circuit in which a plurality of inverters are connected in series may be used, or another circuit having a waveform shaping effect may also be used.

The counter 211 counts the number of pulses that have been output from the waveform shaping unit 210, and holds the count value. In addition, when the control pulse RES is supplied via a drive line 213, the signal held in the counter 211 is reset. Here, the counter 211 generates a signal based on a difference between the count values at the start and end of the accumulation period.

The control pulse SEL is supplied from the vertical scanning circuit 110 in FIG. 3 to the memory 212 via a drive line 214 (not illustrated in FIG. 3) in FIG. 4, and the electrical connection and disconnection between the counter 211 and the vertical signal line 113 are switched. The memory 212 functions as a memory for temporarily storing the count value of the counter, and outputs an output signal from the pixel counter 211 to the vertical signal line 113.

Note that switches such as transistors may be disposed between the quench element 202 and the APD 201 and between the photoelectric conversion unit 102 and the signal processing circuit 103 so that electrical connection is switched. Similarly, the supply of the voltage VH or the voltage VL supplied to the photoelectric conversion unit 102 may be electrically switched by using a switch, for example, a transistor.

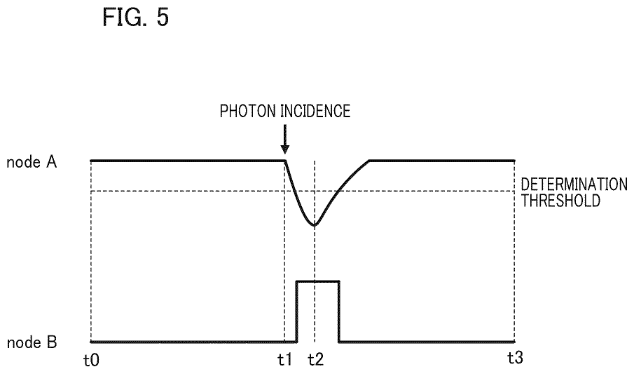

FIG. 5 is a diagram schematically showing the relation between the operation of the APD 201 and the output signal. The input side of the waveform shaping unit 210 is node A, and the output side of the waveform shaping unit 210 is node B. During a period from time to t0 time t1, a potential difference of VH-VL is applied to the APD 201. When a photon is incident on the APD 201 at time t1, avalanche multiplication occurs in the APD 201, an avalanche multiplication current flows in the quench element 202, and the voltage of the node A drops.

When the voltage drop amount further increases and the potential difference applied to the APD 201 decreases, avalanche multiplication of the APD 201 stops as in time t2, and the voltage level of the node A does not decrease to a certain value or less.

Subsequently, during a period from time t2 to time t3, a current that compensates for a voltage drop from the voltage VL flows in the node A, and, at time t3, the node A settles at the original potential level. At this time, a portion where the output waveform exceeds a certain threshold value in the node A is waveform-shaped by the waveform shaping section 210, and output as a pulse signal in the node B.

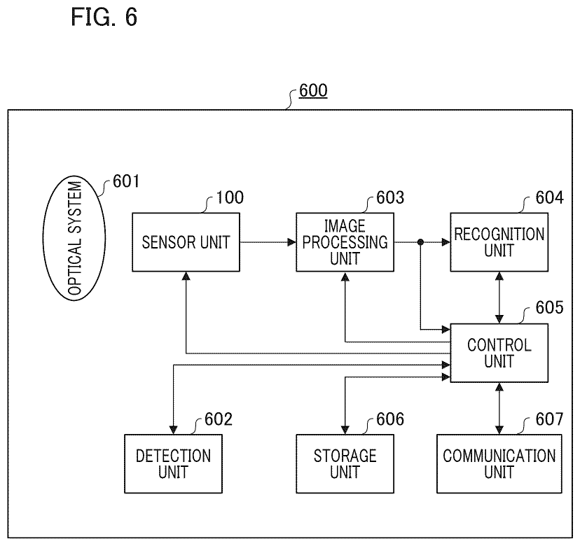

Next, the photoelectric conversion device 600 in the first embodiment will be explained. FIG. 6 is a functional block diagram of the photoelectric conversion apparatus 600 according to the first embodiment. Note that a part of the functional blocks as shown in FIG. 6 is realized by causing a computer (not illustrated) included in the photoelectric conversion device 600 to execute a computer program stored in a memory serving as a storage medium (not illustrated).

However, a part or all of them may be realized by hardware. As hardware, a dedicated circuit (ASIC) and a processor (reconfigurable processor, DSP) can be used.

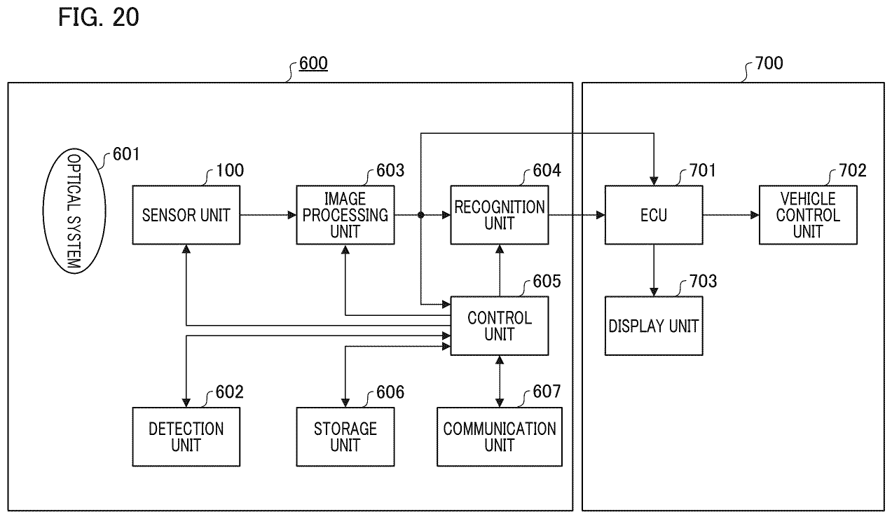

Additionally, each of the functional blocks as shown in FIG. 6 may not be built into the same housing, and may be configured by separate devices connected to each other via signal paths. Note that the above explanation of FIG. 6 also applies to FIG. 20, which will be explained below.

The photoelectric conversion device 600 has the sensor unit 100, the optical system 601, a detection unit 602, an image processing unit 603, a recognition unit 604, the control unit 605, a storage unit 606, a communication unit 607, and the like, which have been described in FIG. 1 to FIG. 5. The sensor unit is configured by the avalanche photodiode as described in FIG. 1 to FIG. 5 for photoelectrically converting an optical image.

The camera unit consisting of the set of the optical system 601 and the sensor unit 100 is configured to capture, for example, an image of at least one of the forward, behind, and side direction of the photoelectric conversion device 600.

In the present embodiment, the optical system 601 is, for example, a wide-angle lens (for example, a fisheye lens) having an angle of view of 120°, and forms an optical image (object image) of an object in front of the photoelectric conversion device 600 on an imaging plane of the sensor unit 100. The detecting unit 602 detects information on the surrounding environment of the photoelectric conversion device 600 (hereinafter, referred to as “environmental information”). Additionally, the positions and sizes of a region of interest and a region of non-interest, which will explained below, are changed according to the output of the detection unit 602.

The image processing unit 603 performs image processing such as black level correction, gamma correction, noise reduction, digital gain adjustment, demosaic processing, and data compression on the image signal obtained by the sensor unit 100 to generate a final image signal. Note that in a case where the sensor unit has an on-chip color filter, for example, RGB, the image processing unit 603 performs processing such as white balance correction and color conversion.

Additionally, the output of the image processing unit 603 is supplied to the recognition unit 604 and the control unit 605. The recognition unit 604 recognizes a photographed person, a vehicle, an object, and the like by performing image recognition based on the image signal. The recognition result performed by the recognition unit 604 is output to the control unit 605 and is reflected in, for example, a change in the control mode of the photoelectric conversion device 600. Furthermore, the recognition result is stored in the storage unit 606 and transmitted to the outside via the communication unit 607 and the like.

The control unit 605 incorporates a CPU serving as a computer and a memory storing a computer program. Additionally, the control unit 605 also functions as a setting unit, and sets the length of the exposure period of each frame of the sensor unit 100, the timing of the control signal CLK, and the like for each region via the control pulse generation unit 115 of the sensor unit 100.

Furthermore, The control unit 605 also functions as an acquisition unit, and acquires sensor characteristic information such as the size and the number of pixels of the sensor unit 100 and optical characteristic information such as the angle of view and the resolution of the optical system 601, as characteristic information of the photoelectric conversion device 600. Furthermore, the control unit 605 acquires information such as an installation height and an installation angle as installation information of the photoelectric conversion device 600 from the detection unit 602, and acquires environmental information on the surrounding environment of the photoelectric conversion device 600 from the detection unit 602.

The CPU executes a computer program stored in a memory built in the control unit 605 based on the information acquired from the detection unit 602, thereby performing control of each unit of the photoelectric conversion device 600.

The storage unit 606 includes a recording medium, for example, a memory card, a hard disk, and the like, and can store and read out image signals. The communication unit 607 includes a wireless or wired interface, and outputs the generated image signal to the outside of the photoelectric conversion device 600 and receives various signals from the outside.

The photoelectric conversion device 600 is used as, for example, a camera, an in-vehicle camera, a pet camera, a monitoring camera, a camera that performs detection or inspection used in a manufacturing line, and a camera for distribution. In addition, the photoelectric conversion device 600 is applicable to various applications such as a medical endoscope camera, a state detection camera for nursing care, an infrastructure inspection camera, and an agricultural camera.

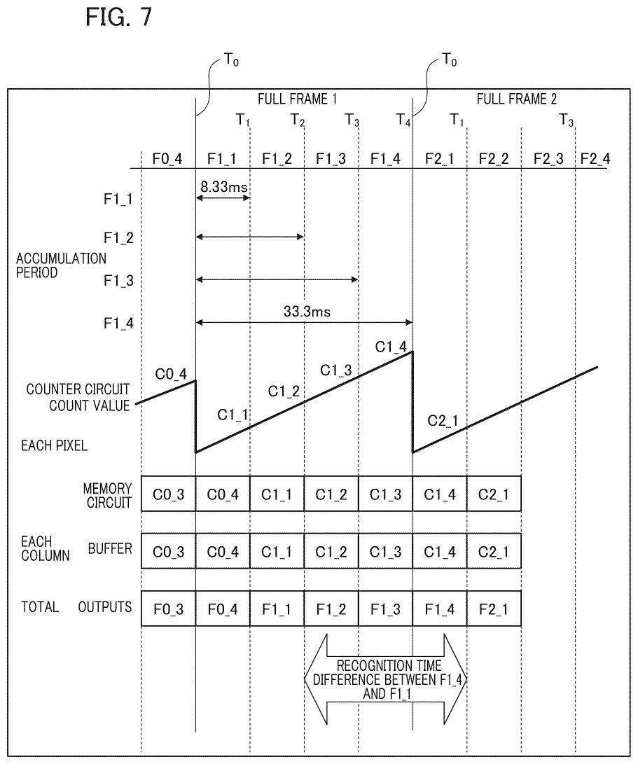

FIG. 7 is a diagram for explaining a photoelectric conversion method performed by the control unit 605 according to the first embodiment. In the present embodiment, photoelectric conversion is periodically driven at, for example, 30 full frames/second. Additionally, a frame corresponding to one vertical period of the length of 33.3 ms is referred to as a full frame, and each of four divisions of the full frame period is referred to as a frame.

That is, as shown in FIG. 7, the full frame 1 is divided into frames 1_1, 1_2, 1_3, and 1_4 each having an equal time period (8.33 ms). Note that, in FIG. 7 and the subsequent drawings, the frame may be abbreviated as “F”.

Note that the frame 1_1 has an accumulation period from the start time T0 to time T1 of the full frame 1, and the frame 1_2 has an accumulation period from time T0 to time T2. Additionally, the frame 1_3 has an accumulation period from time T0 to time T3, and the frame 1_4 has an accumulation period from time T0 to time T4.

In addition, at times T1 to T4, the count values C1_1, C1_2, C1_3, and C1_4 are respectively obtained from the counter 211. Additionally, the count values C1_1, C1_2, C1_3, and C1_4 are temporarily stored in the memory 212.

In addition, The signals of one row temporarily stored in the memory 212 are sequentially output from the sensor unit through the buffer of the readout circuit 112. Additionally, at time T0, the counter 211 is reset. Thus, according to the present embodiment, the signals accumulated during the period of the frame 1_1 are read out during the period from time T1 to time T2, and are promptly processed by the recognition unit 604.

Therefore, the image recognition can be performed quickly. Similarly, signals accumulated in the periods of the frames 1_2, 1_3, and 1_4 are respectively and sequentially read out at times T2 to T3, T3 to T4, and T4 to T1, and the image recognition can be repeatedly performed. Note that the length of the full frame period is not limited to the above example. Additionally, the number of divisions of the full frame period is not limited to four.

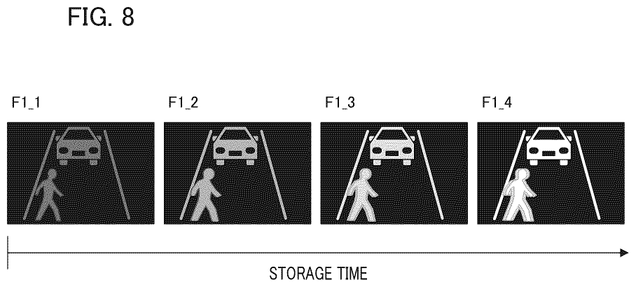

FIG. 8 is a diagram showing an example of images of a plurality of divided accumulation periods according to the first embodiment. Although the image of the frame 1_1 is dark as shown in FIG. 8 since the accumulation period (storage time) is short, a blur of the person who has run out to the road is small. In contrast, the object shaking is likely to occur since the accumulation period becomes longer in the order of the frame 1_2, the frame 1_3, and the frame 1_4. Note that blur is less likely to occur in stopped vehicles and white lines, and contrast is more likely to increase as the accumulation period is longer.

Thus, in the present embodiment, the first accumulation period (for example, the period from time T1 to time T2) and the second accumulation period (for example, the period from time T1 to time T4) are provided within one full frame period, and the first accumulation period is shorter than the second accumulation period. Additionally, control is performed so that a signal generated in the first accumulation period is output between the end of the first accumulation period and the end of the second accumulation period.

Additionally, in the present embodiment, the first accumulation period and the second accumulation period overlap each other, and the first accumulation period and the second accumulation period start at the same time. Furthermore, the end of the second accumulation period coincides with the end of the full frame period, and the second accumulation period is an integral multiple of the first accumulation period.

However, the second accumulation period is not necessarily an integral multiple of the first accumulation period. The second accumulation period is longer than the first accumulation period (the first accumulation period is shorter than the second accumulation period), and it is sufficient that the end of the second accumulation period comes after the end of the first accumulation period.

Specifically, an image having a short accumulation period and an image having a long accumulation period are created, the timing at which the short accumulation period ends is set earlier than the timing at which the long accumulation period ends, and this image is output and sent to the recognition unit 604 in the subsequent stage as soon as the short accumulation period ends.

The object is recognized based on the signal generated at least in the first accumulation period. The recognition unit 604 recognizes the object based on the signal generated at least in the first accumulation period. Therefore, in the present embodiment, the image recognition can be performed after a ¼ full frame period at the shortest, whereas, in the related art, the image recognition cannot be performed until the 1 full frame period has elapsed.

Note that, since the contrast can be improved in an image in which the accumulation period is long, the image can be used as an image for display. That is, an image in which the accumulation period is short is suitable for quick object recognition, and an image in which the accumulation period is long is suitable for an image for display. Therefore, a display unit 703 of the present embodiment displays an image in which the accumulation period is long, that is, a signal generated in the second accumulation period, as an image.

Additionally, since the APD is used in the present embodiment, unlike the CMOS image sensor, the accumulated charge does not deteriorate due to readout, and the accumulation period can be overlapped. Additionally, since there is no readout noise, the original signal does not deteriorate even if the signal is read out a plurality of times by one accumulation.

In contrast, in the CMOS image sensor, it is possible to shorten the accumulation period by increasing the frame frequency, but when the accumulation period is shortened, readout noise is superimposed each time, and the signal-to-noise ratio (S/N) of the output deteriorates. As a result, it is difficult to acquire an image suitable for image recognition.

In addition, Since the same charge needs to be accumulated in the pixel again after readout so that the accumulation period is overlapped in the CMOS image sensor, the circuit becomes complicated and the circuit scale becomes large. Additionally, since noise is superimposed when the electric charge is again accumulated in the pixel, the S/N ratio of the output is significantly deteriorated, and it is difficult to obtain an image suitable for image recognition.

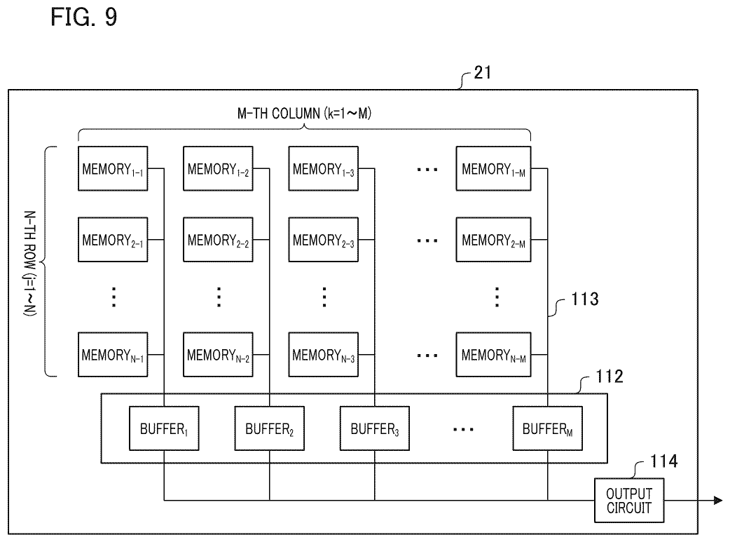

FIG. 9 is a diagram showing the relation between the memory and the buffer in the first embodiment. In FIG. 9, a state is shown in which the memories 212 in the signal processing circuit 103 of FIG. 3 are arranged in N rows and M columns, and each memory 212 is represented as memory 1-1 to memory 1-N. Additionally, buffer 1 to buffer M in FIG. 9 indicate buffers included in the readout circuit 112 in FIG. 3. The output circuit 114 in FIG. 9 corresponds to the output circuit 114 in FIG. 3.

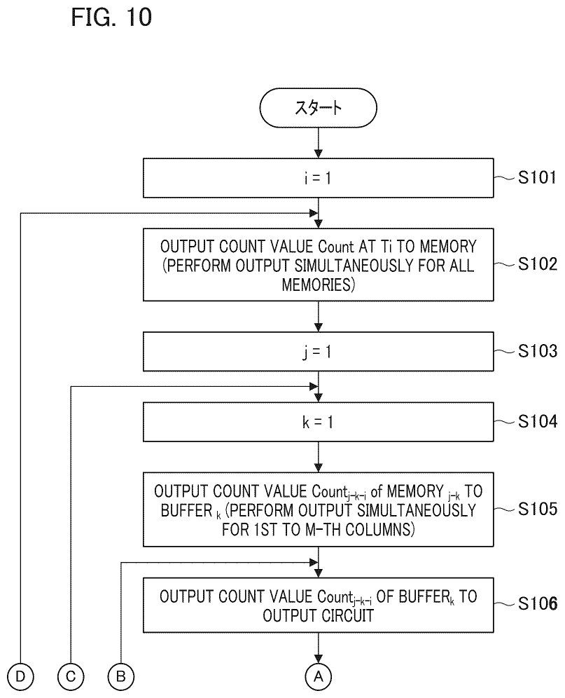

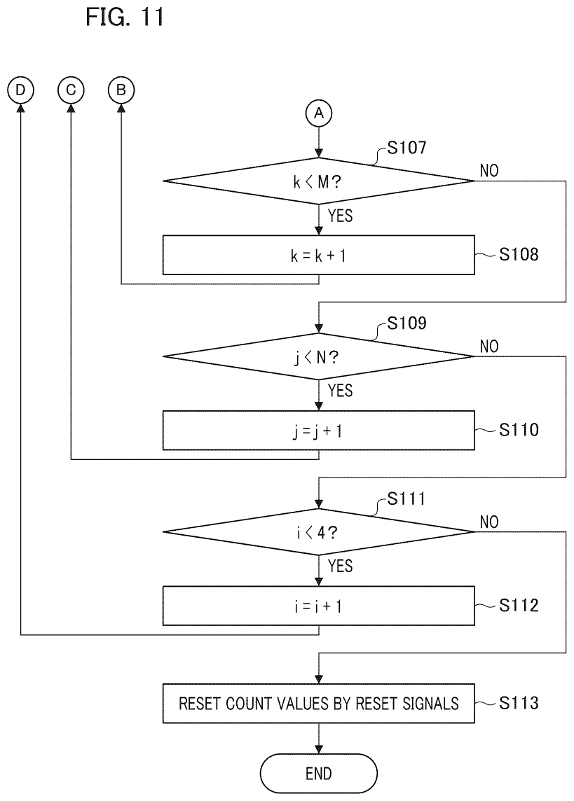

FIG. 10 is a flowchart showing details of an example of driving of the sensor unit 100 in the first embodiment, and FIG. 11 is a flowchart continued from FIG. 10. Note that the operations of each of the steps in the flowcharts of FIG. 10 and FIG. 11 are sequentially performed by the CPU serving as a computer in the control unit 605 executing a computer program stored in the memory.

In step S101 of FIG. 10, the CPU of the control unit 605 sets i=1. Next, in step S102, the CPU of the control unit 605 causes the count value Count of the counter 211 at time T1 to be output to the memory 212. At this time, the output is simultaneously performed for all the memories. This operation corresponds to the operation at time T1 in FIG. 7.

Next, in step S103, the CPU of the control unit 605 sets j=1. Next, in step S104, the CPU of the control unit 605 sets k=1. In step S105, the CPU of the control unit 605 causes the count value Count (j−k−i) in the memory j−k of FIG. 9 to be output to the buffer. At this time, the outputs to the buffers are performed simultaneously for the first to M-th columns. This operation denotes an operation of taking the count value of the first row in FIG. 9 into the buffer.

In step S106, the CPU of the control unit 605 causes the count value Count (j−k−i) of the buffer k to be output to the output circuit 114. This operation corresponds to the operation of reading out the signals of the buffers in the leftmost column in FIG. 9 from the output circuit.

Next, the process proceeds to step S107 in FIG. 11 via A, and in step S107, the CPU of the control unit 605 determines whether or not k<M. If the determination result in step S107 is “YES”, in S108, k=k+1 is set and k is incremented by 1, the process returns to step S106 via B, and the operation of step S106 is performed. This operation corresponds to the operation of reading out the signal of the buffer in the second column from the left in FIG. 9 from the output circuit.

If the determination result in step S107 is “NO”, that is, if k=M is obtained, it means that the signal of the buffer in the M-th column in FIG. 9 has already been read out from the output circuit, and the process proceeds to step S109, where the CPU of the control unit 605 determines whether or not j<N. If the determination result in step S109 is “YES”, in step S110, the CPU of the control unit 605 sets j=J+1 and increments j by 1, and the process returns to step S104 via C. This corresponds to the operation for starting the readout of the next row.

If the determination result is “NO” in step S109, this means that the readout for all the rows has been completed, and thus, the process proceeds to step S111, where the CPU of the control unit 605 determines whether or not i<4. If the determination result in step S111 is “YES”, in step S112, the CPU of the control unit 605 sets i=i+1 and increments i by 1, and the process returns to step S102 via D. This operation corresponds to the operation for starting the readout at the next time T2.

If the determination result in step S111 is “NO”, this means that the readout at time T4 has been completed, and thus the process proceeds to step S113, where the CPU of the control unit 605 causes the counter 211 to be reset by a reset signal. This operation corresponds to the reset operation of the counter 211 at time T4 in FIG. 7. Note that the flow of FIG. 10 and FIG. 11 is repeated periodically. Thus, the signals accumulated in the sensor unit can be read out sequentially.

In the sensor unit, in the case of the circuit configuration as shown in FIG. 9, it is possible to change the setting of the accumulation period for each column.

For example, in the first column (k=1), the accumulation period of the full frame 1 is changed to the frame 1_1, the frame 1_2, the frame 1_3, and the frame 1_4 as shown in FIG. 7 to read four data. That is, the first column is set as the first image region having a short accumulation period.

In contrast, in the second column (k=2), it is also possible to divide the period of the full frame 1 into two periods, and read out only two data of the accumulation periods of the frame 1_2 and the frame 1_4. That is, the second column is set as the second image region having a long accumulation period.

Thus, the accumulation period and the number of times of accumulation can be arbitrarily changed, and the intensity of the signal to be accumulated can be changed or the number of times of accumulation can be increased or decreased by changing the accumulation period and the number of times of accumulation. Additionally, the data amount can be increased or decreased according to the number of times of accumulation. However, as the amount of data increases, the power consumption of the sensor unit and the photoelectric conversion device 600 also increases.

The method of changing the setting of the accumulation period is not limited to a method of changing the setting for each column, and it is also possible to change the setting of the accumulation period for each row or change the setting of the accumulation period for each pixel by changing the signal line of the sensor unit 100. This setting of the accumulation period for each region or each pixel is performed by the control unit 605.

As described above, the control unit 605 incorporates the CPU serving as a computer and a memory storing a computer program, acquires information from the detection unit 602, and the CPU executes the computer program stored in the memory based on the information. Thus, the accumulation period can be set for each region or for each pixel.

Thus, the control unit 605 sets the accumulation period for each region or for each pixel of the sensor unit 100, and the timing at which the short accumulation period ends can be set earlier than the timing at which the long accumulation period ends. Therefore, as soon as the short accumulation period ends, the image can be output and sent to the recognition unit 604 in the subsequent stage.

Specifically, in the recognition unit 604, the object in the image region in which a accumulation period is short can be recognized at T1 time when the frame 1_1 ends, which is earlier than T4 time when the full frame 1 ends in the first column (k=1), based on the signal generated in the first accumulation period. Therefore, although, in the related art, image recognition cannot be performed until one full frame period elapses, and in contrast, in the present embodiment, it is possible to set a region in which image recognition can be performed in a shorter time.

Additionally, since an image can be acquired in a plurality of accumulation periods, an image with appropriate exposure can be generated for both a bright region and a dark region. Consequently, the signal-to-noise ratio (S/N) of each region can be maximized. That is, in a dark region, the signal can be increased by a long accumulation period and the S/N can be maximized.

In contrast, in a bright region, a signal can be acquired without saturation of the signal by a short accumulation period, and the S/N ratio can be maximized. Therefore, it is possible to acquire an image in which the signal is not saturated, noise is suppressed, and the S/N ratio is maximized for each region by applying an accumulation period suitable for each region.

Additionally, it is possible to suppress shaking due to the movement of the object by applying an accumulation period suitable for each region. In a long accumulation period, there is a possibility that the object becomes a blurred image (blur). In contrast, in a short accumulation period, blurring of the object can be reduced. Therefore, it is possible to acquire an image in which blurring due to the movement of the object is reduced by applying an appropriate accumulation period.

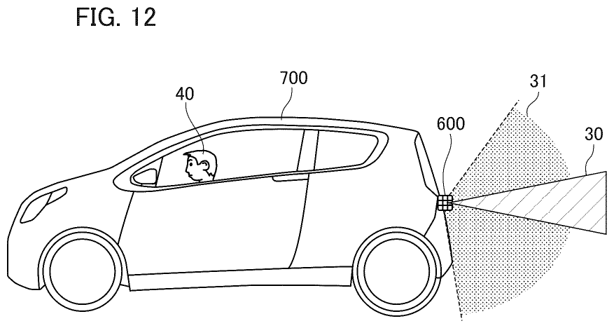

Next, the characteristics of the optical system 601 will be explained in detail. FIG. 12 is a diagram that explains an example of the mounting position of the photoelectric conversion device 600 according to the first embodiment. FIG. 12 shows a case where the movable apparatus 700 is an automobile (vehicle). Additionally, FIG. 12 shows a case where the photoelectric conversion device 600 is an in-vehicle camera.

The movable apparatus 700 includes an in-vehicle system (driving assistance device, display system) (not illustrated) for assisting a user 40 (driver, fellow passenger, and the like) of the movable apparatus 700 by using an image acquired by the photoelectric conversion device 600.

Although, in the present embodiment, the case where the photoelectric conversion device 600 is installed so as to capture an image behind the movable apparatus 700 is shown, the photoelectric conversion device 600 may be installed so as to capture an image in the forward direction, the side direction, and the like of the movable apparatus 700. Additionally, two or more photoelectric conversion devices 600 may be installed at two or more places of the movable apparatus 700.

As described above, the photoelectric conversion device 600 has the optical system 601 and the sensor unit 100. The optical system 601 has a first angle of view (first field of view) 30 and a second angle of view (second field of view) 31 outside (on the periphery side of) the first angle of view 30.

Additionally, the optical system 601 is an optical system (different angle-of-view lens) in which the first angle of view 30 and the second angle of view 31 have different imaging magnifications. The imaging plane (light receiving surface) of the sensor unit 100 includes a first region that images an object included in the first angle of view 30 and a second region that images an object included in the second angle of view 31.

At this time, the number of pixels per unit angle of view in the first region is larger than the number of pixels per unit angle of view in the second region excluding the first region. In other words, the resolution in the first angle of view (first region) of the photoelectric conversion device 600 is higher than the resolution in the second angle of view (second region).

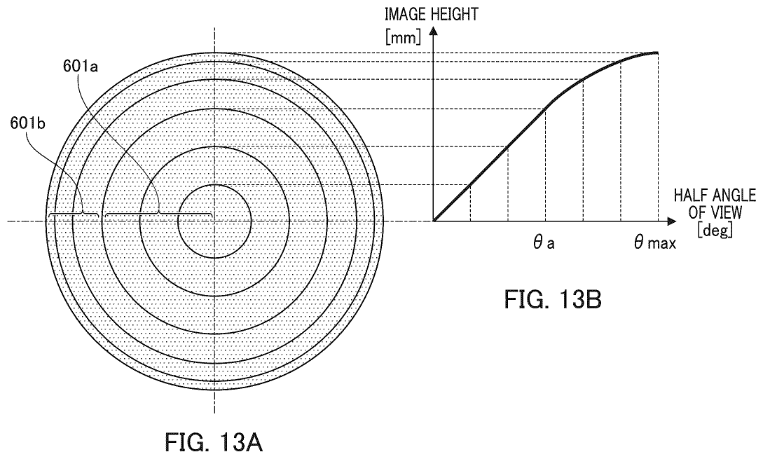

FIGS. 13A and 13B are diagrams that explain optical characteristics of the optical system 601 according to the first embodiment.

FIG. 13A is a diagram showing the image height y at each half angle of view on the imaging plane (light receiving surface of the image sensor) of the sensor unit 100 in a contour form. FIG. 13B is a diagram showing the relation between the half angle of view θ and the image height y in the first quadrant of FIG. 13A (the projection characteristic of the optical system 601).

The optical system 601 is configured such that the projection characteristics y(θ) are different at an angle of view less than a predetermined half angle of view θa and at an angle of view equal to or greater than the half angle of view θa, as shown in FIG. 13B. Therefore, the optical system 601 is configured such that the resolution differs depending on the angle of view (the region on the light receiving surface of the sensor unit) in a case where the amount of increase in the image height y with respect to the half angle of view θ per unit is defined as the resolution.

This local resolution can be expressed by a differential value dy(θ)/dθ at a half angle of view θ of the projection characteristic y(θ). For example, it can be said that as the gradient of the projection characteristic y(θ) in FIG. 13B becomes higher, the resolution is higher. Additionally, it is shown in FIG. 13A that as the interval between the level contour lines of the image height y at each half angle of view becomes larger, the resolution is higher.

The optical system 601 in the present embodiment has a projection characteristic in which the rate of increase of the image height y (the inclination of the projection characteristic y(θ) in FIG. 13B) becomes large in the central region in the vicinity of the optical axis, and the rate of increase of the image height y becomes smaller as the angle of view increases in the peripheral region outside the central region.

In FIG. 13A, a first region 601a including the center corresponds to an angle of view smaller than the half angle of view θa, and a second region 601b outside the first region corresponds to an angle of view equal to or larger than the half angle of view θa. Additionally, the angle of view smaller than the half angle of view θa corresponds to the first angle of view 30 in FIG. 12, and the angle of view equal to or larger than the half angle of view θa corresponds to the second angle of view 31 in FIG. 12.

As described above, the first region 601a is a region of relatively high resolution, and the second region 601b is a region of relatively low resolution. Additionally, the first region 601a is a low distortion region in which the distortion is relatively small, and the second region 601b is a high distortion region in which the distortion is relatively large. Accordingly, in the present embodiment, the first region 601a may be referred to as a high resolution region or a low distortion region, and the second region 601b may be referred to as a low resolution region or a high distortion region.

Thus, the optical system 601 in the present embodiment forms object images having different resolutions in the first pixel region and the second pixel region on the light receiving surface of the sensor unit consisting of a plurality of pixels. Note that the characteristics shown in FIG. 13 are simply an example, and the present invention is not limited thereto. For example, the low resolution region and the high resolution region of the optical system need not be concentrically configured, and the respective regions may have distorted shapes.

Additionally, the centroid of the low resolution region and the centroid of the high resolution region need not coincide with each other. Additionally, the centroid of the low resolution region and the centroid of the high resolution region may be shifted from the center of the light receiving surface of the sensor unit. Additionally, in the optical system of the present embodiment, the high resolution region may be formed in the vicinity of the optical axis, and the low resolution region may be formed in the peripheral side away from the vicinity of the optical axis (outside the high resolution region).

The projection characteristic y(θ) in the first region 601a (high resolution region) of the optical system 601 is set to be different from the projection characteristic in the second region 601b (low resolution region). The configuration is such that the projection characteristic y(θ) in the first region 601a (high resolution region) is larger than f×θ (f is the focal length of the optical system 601).

Note that in the case where θmax is the maximum half angle of view of the optical system 601, it is desirable that the ratio θa/θmax of θa and θmax is equal to or greater than a predetermined lower limit value, and for example, 0.15 to 0.16 is desirable as the predetermined lower limit value.

Additionally, the ratio θa/θmax of θa and θmax is desirably a predetermined upper limit value or less, and is desirably, for example, 0.25 to 0.35. For example, in a case where θmax is 90°, and the predetermined lower limit is 0.15 and the predetermined upper limit is 0.35, it is desirable that θa is determined to be in a range of 13.5° to 31.5°. However, the above is an example, and the present invention is not limited thereto.

Additionally, the optical system 601 is configured so that its projection characteristic y(θ) satisfies the following Formula (1).

$$1 < \frac{f \times sin {θ}_{max}}{y ( {θ}_{max} )} \leq A \qquad ( Formula 1 )$$

Here, f is the focal length of the optical system 601 as described above, A is a predetermined constant, and the constant A may be determined in consideration of the balance between the resolution of the high resolution region and the resolution of the low resolution region, and is desirably set to 1.4 to 1.9.

It is possible to make the center resolution higher than a fisheye lens of an orthogonal projection system (y=f×sin θ) having the same maximum image height by setting the lower limit value to 1, and it is possible to maintain good optical performance while obtaining an angle of view equivalent to that of a fisheye lens by setting the upper limit value to A. However, the above is an example, and the present invention is not limited thereto.

By configuring the optical system 601 as described above, a high resolution can be obtained in the first region 601a (high resolution region), and an amount of increase in the image height y with respect to the half angle of view θ per unit can be reduced in the second region 601b (low resolution region).

Consequently, it is possible to image a wider angle of view, and it is possible to obtain high resolution in the high resolution region while setting a wide angle of view equivalent to that of a fisheye lens as an image capturing range. Additionally, according to the present embodiment, it is possible to provide a photoelectric conversion device capable of setting different accumulation periods for regions having different resolutions.

### Second Embodiment

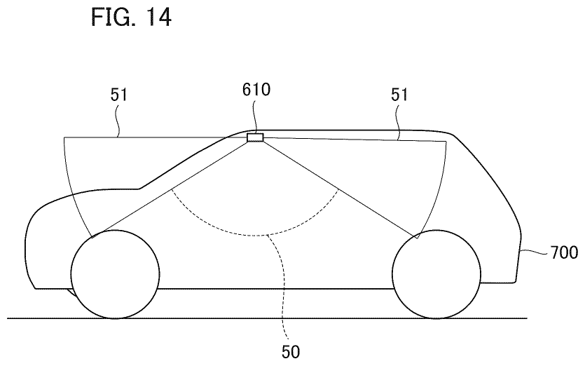

Next, the second embodiment will be explained. FIG. 14 is a diagram that explains an example of the mounting position of a photoelectric conversion device 610 according to the second embodiment, and shows a case where the movable apparatus 700 is an automobile (vehicle) as in the first embodiment.

Additionally, FIG. 14 shows the case where the photoelectric conversion device 610 is an in-vehicle camera. The movable apparatus 700 includes an in-vehicle system (driving assistance device) (not illustrated) for assisting a user (driver, fellow passenger, and the like) (not illustrated) by using an image that has been acquired by the photoelectric conversion device 610.

Although, in the present embodiment, the case where the photoelectric conversion device 610 is installed on the side of the movable apparatus 700 is shown, the photoelectric conversion device 610 may be installed on the front side or the rear side of the movable apparatus 700. Additionally, two or more photoelectric conversion devices 610 may be installed at two or more places of the movable apparatus 700.

The photoelectric conversion device 610 has an optical system 611 and a sensor unit. The optical system 611 is an optical system (inverted different-angle-of-view lens) in which the imaging magnification is different between a first angle of view (first field of view) 50 and a second angle of view (second field of view) 51 more on the peripheral side (outside the first angle of view) than the first angle of view 50.

The imaging plane (light receiving surface) of the sensor unit 100 includes a first region that images an object included in the first angle of view 50 and a second region that images an object included in the second angle of view 51. At this time, the number of pixels per unit angle of view in the second region is larger than the number of pixels per unit angle of view in the first region. In other words, the resolution in the second angle of view (second region) of the photoelectric conversion device 610 is higher than the resolution in the first angle of view (first region).

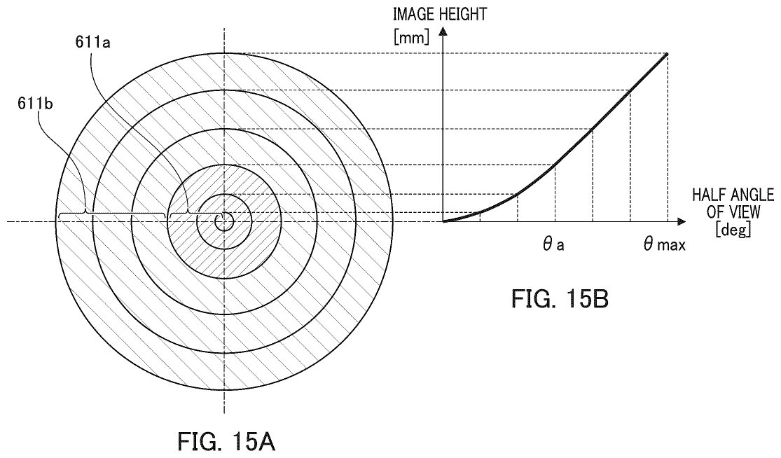

FIGS. 15A and 15B are diagrams that explain optical characteristics of the optical system 601 according to the second embodiment.

FIG. 15A is a diagram showing the image height y at each half angle of view on the imaging plane (light receiving surface) of the sensor unit 100 in contour form. FIG. 15B is a diagram showing the relation between the half angle of view θ and the image height y (projection characteristic of the optical system 611) in the first quadrant of FIG. 15A.

The optical system 611 is configured such that the projection characteristics y(θ) are different at an angle of view less than a predetermined half angle of view θa and at an angle of view equal to or greater than the half angle of view θa, as shown in FIG. 15B. Accordingly, the optical system 611 is configured such that the resolution angle differs depending on the angle of view (the region on the light receiving surface of the sensor unit) in a case where an amount of increase in the image height y with respect to the half angle of view θ per unit is defined as the resolution.

This local resolution can be expressed by a differential value by(θ)/bθ at the half angle of view θ of the projection characteristic y(θ). For example, it can be said that as the gradient of the projection characteristic y(θ) in FIG. 15B is higher, the resolution is higher. Additionally, it is shown in FIG. 15A that as the interval of the level contour line of the image height y at each half angle of view is larger, the resolution is higher.

The optical system 611 of the present embodiment has a projection characteristic in which the rate of increase in the image height y (the gradient of the projection characteristic y(θ) in FIG. 15B) is small in the central region near the optical axis and the rate of increase in the image height y increases as the angle of view increases in a peripheral region outside the central region.

In FIG. 15A, a first region 611 a including the center corresponds to an angle of view less than the half angle of view θa, and a second region 611b outside the first region corresponds to an angle of view equal to or greater than the half angle of view θa. Additionally, the angle of view smaller than the half angle of view θa corresponds to the first angle of view 50 in FIG. 14, and the angle of view equal to or larger than the half angle of view θa corresponds to the second angle of view 51 in FIG. 14.

As described above, the first region 611a is a region where the resolution is relatively low, and the second region 611b is a region where the resolution is relatively high. Additionally, the first region 611a is a high distortion region where the distortion is a relatively large, and the second region 611b is a low distortion region where the distortion is relatively small. Accordingly, in the present embodiment, the first region 611a may be referred to as a low resolution region or a high distortion region, and the second region 611b may be referred to as a high resolution region or a low distortion region.

Note that the characteristic as shown in FIG. 15 is an example, and the present invention is not limited thereto. For example, the low resolution region and the high resolution region of the optical system need not be concentrically configured, and the respective regions may have distorted shapes.

Additionally, the centroid of the low resolution region and the centroid of the high resolution region need not coincide with each other. Additionally, the centroid of the low resolution region and the centroid of the high resolution region may be shifted from the center of the light receiving surface of the sensor unit. In the optical system of the present embodiment, the low resolution region may be formed in the vicinity of the optical axis, and the high resolution region may be formed on the peripheral side away from the optical axis (outside the low resolution region).

The optical system 611 is configured to satisfy the following Formula 2 where f is a focal length, θ is a half angle of view, y is an image height on an imaging plane, a projection characteristic representing a relation between the image height y and the half angle of view θ is y(θ), and θmax is the maximum half angle of view of the optical system. That is, the optical system 611 is configured such that the projection characteristic y(θ) is different from 2f tan (θ/2) (stereoscopic projection method).

$$0.2 < 2 \times f \times tan ( θmax / 2 ) / y ( θ max ) < 0.92 \qquad ( Formula 2 )$$

In an optical system having such optical characteristics, the magnification in the radial direction with respect to the optical axis can be adjusted by adjusting the projection characteristic y(θ). Thus, it is possible to control the aspect ratio in the radial direction and the circumferential direction with respect to the optical axis, and therefore, it is possible to obtain a high resolution image with little distortion in the peripheral region while having a wide angle of view, unlike a conventional fisheye lens and the like.

Additionally, the resolution in the second region 611b can be set higher than that of the optical system of the stereoscopic projection method by satisfying the above Formula 2. Note that if the upper limit of Formula (2) is exceeded, the resolution in the second region 611b becomes low, and the difference between the resolution in the first region 611a and the resolution in the second region 611b becomes small, which is not preferable.

Additionally, if the lower limit of Formula 2 is not reached, it becomes difficult to favorably correct various aberrations such as field curvature, which is not preferable. Note that the above Formula 2 is an example, and the optical system according to the second embodiment is not limited thereto.

By configuring the optical system as described above, high resolution can be obtained in the high resolution region, while an amount of increase in the image height y per unit half angle of view θ is reduced in the low resolution region, and a wider angle of view can be imaged. Therefore, high resolution can be obtained in the high resolution region while the wide angle of view equivalent to that of the fisheye lens is set as the image capturing range.

Additionally, in the present embodiment, in the high resolution region (low distortion region), the projection characteristic is approximate to the central projection method (y=f×tan θ) and the equidistant projection method (y=f×θ), which are the projection characteristics of general image capturing optical systems. Therefore, in the high resolution region (low distortion region), a fine image with small optical distortion can be generated.

### Third Embodiment

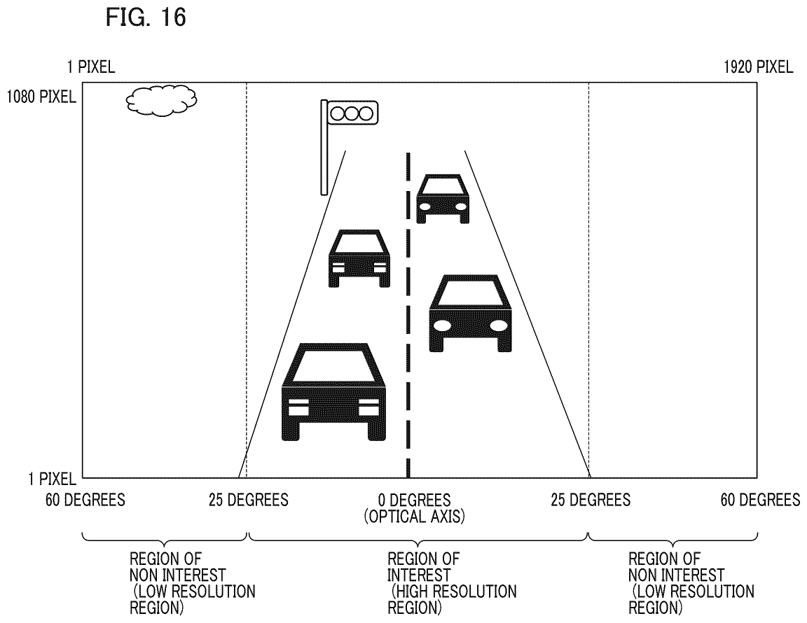

Next, a method of setting a region of interest in the third embodiment will be explained. FIG. 16 is a diagram that explains the settings of a region of interest in the third embodiment. In FIG. 16, an example will be explained in which the photoelectric conversion device 600 according to the first embodiment using the optical system 601 in which the reference numeral 601a denotes a high resolution region and the reference numeral 601b denotes a low resolution region is mounted on the front or the rear of the movable apparatus 700.

In that case, a range in the vicinity of the optical axis in front or behind is a high resolution region, and a peripheral range away from the vicinity of the optical axis is a low resolution region. In FIG. 16, an image captured by mounting the photoelectric conversion device 600 to the front of the movable apparatus 700 is shown. In the photoelectric conversion device 600, it is assumed that the left and right angles of view of the optical system 601 are 120 degrees, and the up and down angles of view are 30 degrees. Additionally, the number of pixels of the sensor unit 100 is 1920 pixels in the M-row direction and 1080 pixels in the N-column direction.

Then, a range in the vicinity of the optical axis at 50 degrees to the left and right from the optical axis is a high resolution region, and this range is set in a first pixel region serving as a region of interest. Additionally, a peripheral range (outside the first pixel region) that is outside this range and away from the vicinity of the optical axis is a low resolution region, and this range is set in the second pixel region serving as a region of non-interest.

Specifically, in the third embodiment, the control unit sets the second pixel region on the peripheral side of the light receiving surface in a case where the resolution in the vicinity of the optical axis of the optical system is higher than the resolution on the peripheral side away from the optical axis. Note that the accumulation period in the second pixel region serving as a region of non-interest is set as a second accumulation period.

For example, when the movable apparatus 700 is moving forward or backward, the range in the vicinity of the optical axis captures an image in the traveling direction of the movable apparatus 700, and grasping of traffic participants and obstacles present around the traveling direction is important for reducing the collision risk. Additionally, signals and traffic signs are also present in the vicinity of the traveling direction, and it is desirable to quickly and accurately grasp the signals and the indicators.

Therefore, in the third embodiment, the vicinity of the optical axis is set to the first pixel region serving as a region of interest, and, in the first pixel region, an image is acquired in an accumulation period shorter than a full frame period. Consequently, it is possible to obtain an image in which the image can be recognized earlier than the full frame period, the S/N of the movable apparatus is high, and blurring due to motion is small.

In contrast, the peripheral range away from the vicinity of the optical axis is low in risk of collision, and thus, it is sufficient if an image is captured, and, in many cases, an image with a high S/N ratio and an image with little blurring is not required. Therefore, these regions are set in the second pixel region serving as region of non-interest, and, in the second pixel region, an image in a relatively long accumulation period (for example, a full-frame period) is acquired during the full frame period.

Thus, in the present embodiment, the control unit performs control so that the accumulation period in one of the first pixel region and the second pixel region becomes one of the first accumulation period and the second accumulation period. Specifically, the first pixel region and the second pixel region are appropriately set based on the projection characteristics of the optical system 601 of the photoelectric conversion device 600, and image capturing is performed in different accumulation periods in each of the regions.

As a result, an image can be recognized earlier than the full frame period. Furthermore, it is possible to reduce an amount of data and power consumption while increasing the S/N ratio and reducing the blurring of pixels due to motion.

### Fourth Embodiment

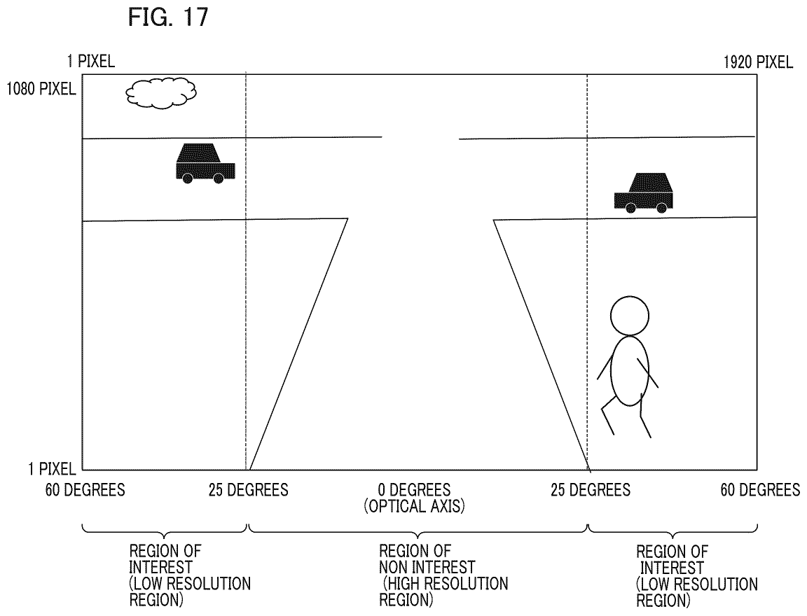

Next, another method of setting a region of interest in the fourth embodiment will be explained. FIG. 17 is a diagram that explains the settings of a region of interest in the fourth embodiment. In the fourth embodiment, in a case where an optical system similar to that in the third embodiment is used, the settings of the region of interest (first region) and the setting of the region of non-interest (second region) are reversed.

Specifically, the second pixel region is set on the center side of the light receiving surface in a case where the resolution in the vicinity of the optical axis of the optical system is higher than the resolution on the peripheral side away from the optical axis. Thus, in the fourth embodiment, the control unit sets the pixel region having a relatively high resolution in the light receiving surface as the second pixel region, and sets the accumulation period in the second pixel region as the second accumulation period.

In the fourth embodiment, similar to the third embodiment, a case where the photoelectric conversion device 600 using the optical system 601 of the first embodiment, in which the reference numeral 601a denotes a high resolution region and the reference numeral 601b denotes a low resolution region, is mounted on the front or rear of the movable apparatus 700 is assumed.

Specifically, the range in the vicinity of the optical axis at 50 degrees to the right and left from the optical axis is the high resolution region, and the range of this high resolution region is set as the second pixel region serving as a region of non-interest. Additionally, a peripheral range that is outside this range and away from the vicinity of the optical axis is a low resolution region, and this range of the low resolution region is set as the first pixel region as a region of interest.

Thus, in the fourth embodiment, the second pixel region is provided inside the first pixel region, and the second pixel region is arranged adjacent to the first pixel region.

For example, when the movable apparatus 700 is moving forward or backward, a peripheral range away from the vicinity of the optical axis captures an image of a side surface in the traveling direction of the movable apparatus 700. This is because the risk of collision with the movable apparatus 700 due to a rushing out from the side surface in the traveling direction is high, and thus grasping of a traffic participant and an obstacle present on the side surface is important for reducing the collision risk.

In contrast, it suffices if the presence of the rushing out from the side surface can be quickly grasped, and it is not always necessary to acquire this presence as a high resolution image. This is because, in the case of rushing out from the side, it suffices if whether or not anything heading in the traveling direction of the movable apparatus 700 is present can be quickly grasped, and it is important to stop to avoid a collision regardless of whether it is a car, a person, or an object.

Accordingly, in the fourth embodiment, the vicinity away from the vicinity of the optical axis is set as the first pixel region serving as a region of interest, and an image in the accumulation period shorter than the full frame period is acquired, whereby it is possible to recognize the image earlier than the full frame period.

In contrast, since collision risk is low in the range in the vicinity of the optical axis, it suffices if image capturing is performed in the accumulation period of the full frame period. Therefore, these regions are set as the second pixel region serving as a region of non-interest, and an image in the full frame period is acquired, whereby the data amount of the captured image can be reduced.

Thus, also in the fourth embodiment, the control unit performs control so that the accumulation period in one of the first pixel region and the second pixel region is one of the first accumulation period and the second accumulation period. Specifically, the first pixel region and the second pixel region are appropriately set based on the projection characteristics of the optical system 601 of the photoelectric conversion device 600, and image capturing is performed in different accumulation periods in each of the regions. Consequently, it is possible to recognize the image earlier than the full frame period, and possible to reduce the data amount and power consumption.

### Fifth Embodiment

The fifth embodiment will be explained. In the fifth embodiment, a method of setting a region of interest in a case where an optical system having characteristics as shown in FIG. 15 is used will be explained.

That is, as shown in FIG. 15, a case is assumed in which the photoelectric conversion device 610 using an optical system 611, in which the reference numeral 611a denotes a low resolution region and the reference numeral 611b denotes a high resolution region, is mounted on the side of the movable apparatus 700. In this case, a peripheral region away from the vicinity of the optical axis in the lateral direction becomes a high resolution region, and a region in the vicinity of the optical axis becomes a low resolution region.

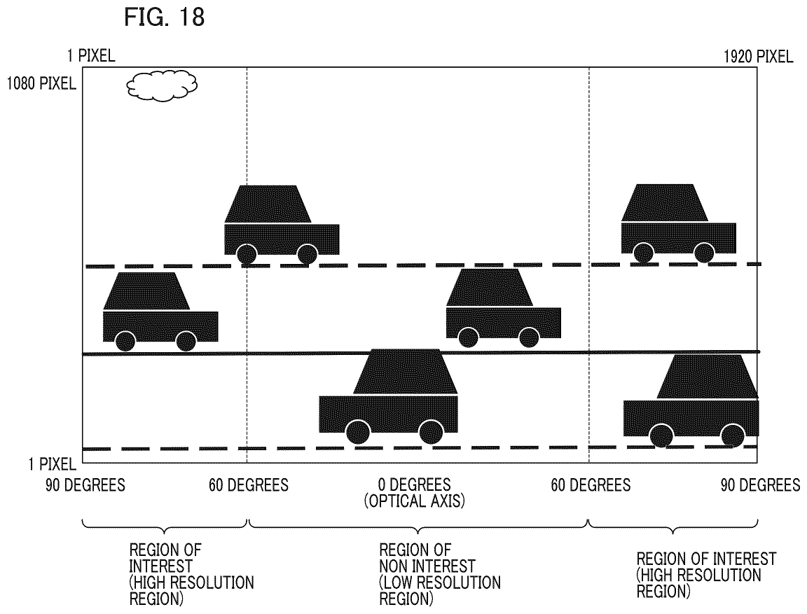

FIG. 18 is a diagram that explains settings of a region of interest in the fifth embodiment, and shows, for example, an image captured by mounting the photoelectric conversion device 610 on the side of the movable apparatus 700. In the photoelectric conversion device 610, it is assumed that the left and right angles of view of the optical system 611 are 180 degrees, and the up and down angles of view are 30 degrees. Additionally, the number of pixels of the sensor unit 100 is 1920 pixels in the M-row direction and 1080 pixels in the N-column direction.

In addition, a range in the vicinity of the optical axis at 120 degrees to the right and left from the optical axis is a low resolution region, and this range is set as a second pixel region serving as a region of non-interest, and a peripheral range that is outside this range and away from the vicinity of the optical axis is a high resolution region, and this range is set as a first pixel region serving as a region of interest.

For example, when the movable apparatus 700 is moving forward, the peripheral range away from the vicinity of the optical axis captures an image of the front side surface and the rear side surface in the traveling direction of the movable apparatus 700. This means that another movable apparatus traveling in the same direction as the movable apparatus 700 or another movable apparatus traveling in the opposite direction to the movable apparatus 700 is imaged on the front side or the rear side in the traveling direction.

When the movable apparatus 700 changes lanes, it is necessary to quickly determine the presence of another movable apparatus that is traveling in the same direction as the movable apparatus 700 on the front side surface or the rear side surface in the traveling direction, and evaluate the risk of collision.

Additionally, in the front side of the travel direction, it is necessary to quickly determine whether or not another movable apparatus that is travelling in the opposite direction to the movable apparatus 700 is entering the travelling direction of the movable apparatus 700 and evaluate the risk of collision. Thus, the grasping of a traffic participant and an obstacle that are present on the front side surface and the rear side surface in the traveling direction of the movable apparatus 700 is important for reducing the collision risk. Additionally, a signal and a traffic sign are also present on the front side, and it is necessary to grasp the signal and the traffic sign quickly and accurately.

Accordingly, in the fifth embodiment, the vicinity away from the vicinity of the optical axis is set as the first pixel region serving as a region of interest, and an image is acquired in the accumulation period shorter than the full frame period. Consequently, it is possible to obtain an image in which the image can be recognized earlier than the full frame period, the S/N of the movable apparatus is high, and blurring due to motion is small.

In contrast, the range in the vicinity of the optical axis is a range in which the collision risk is low during, for example, straight traveling, and thus, it suffices if image capturing is performed in the accumulation period of the full frame period. Therefore, these regions are set as the second pixel region serving as a region of non-interest, and an image in the full frame period is acquired, whereby the data amount of the captured image can be reduced.

Thus, also in the fifth embodiment, the control unit performs control so that the accumulation period in one of the first pixel region and the second pixel region is one of the first accumulation period and the second accumulation period. Specifically, the first pixel region and the second pixel region are appropriately set based on the projection characteristics of the optical system 611 of the photoelectric conversion device 610, and image capturing is performed in different accumulation periods in each of the regions.

As a result, an image can be recognized earlier than the full frame period, the S/N ratio can be increased, and the amount of data and power consumption can be reduced while reducing the blurring of pixels due to motion.

### Sixth Embodiment

Next, the sixth embodiment will be explained. In the sixth embodiment, in a case where the optical system similar to that in the fifth embodiment is used, the settings of the region of interest (first region) and the region of non-interest (second region) are reversed.

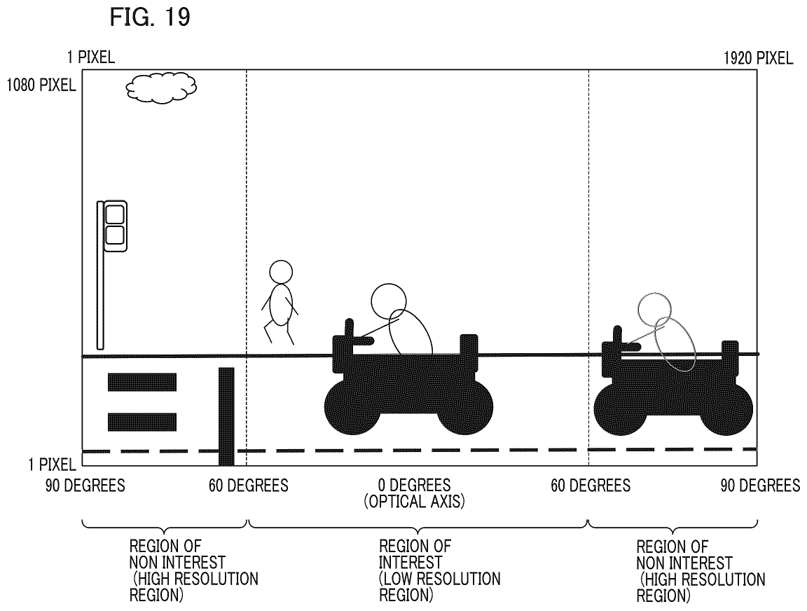

FIG. 19 is a diagram that explains settings of a region of interest in the sixth embodiment. The photoelectric conversion device 610, using the optical system 611 in which the reference numeral 611a denotes the low resolution region and the reference numeral 611b denotes the high resolution region, is mounted on the side of the movable apparatus 700. In this case, a peripheral region away from the vicinity of the optical axis in the lateral direction becomes a high resolution region, and a region in the vicinity of the optical axis becomes a low resolution region.

The photoelectric conversion device 610 according to the sixth embodiment is set to have a right and left angle of view of 180 degrees and an up and down angle of view of 30 degrees of the optical axis 611, and the number of pixels of the sensor unit 100 is set to 1920 pixels in the M-row direction and 1080 pixels in the N-column direction.

Additionally, a range of 120 degrees in the vicinity of the optical axis to the right and left is a low resolution region, and this range is set as the first pixel region serving as a region of interest. Additionally, a peripheral range that is outside this range and away from the vicinity of the optical axis is a high resolution region, and this range is set as the second pixel region serving as a region of non-interest.

For example, when the movable apparatus 700 is moving forward, the range in the vicinity of the optical axis captures an image of a side surface of the movable apparatus 700 in the traveling direction. Thus, another movable apparatus traveling in the same direction as the movable apparatus 700 or another movable apparatus traveling in the opposite direction to the movable apparatus 700 is imaged on the side surface.

In particular, in a case where the movable apparatus 700 is an automobile, there are cases where a motorcycle, a bicycle, which are small-sized mobile bodies, a pedestrian, and the like, are imaged. There is a case where it is necessary to quickly determine the presence of such small movable apparatus and pedestrians, and evaluate the risk of collision, particularly the risk of collision caused by the vehicle's turning to the right or left.

Thus, grasping of a motorcycle and the like and an obstacle that are present on the side surface of the movable apparatus 700 is important for reducing the collision risk. Therefore, in the sixth embodiment, the vicinity of the optical axis is set as the first pixel region serving as a region of interest, and an image is acquired in the accumulation period shorter than the full frame period, and thereby an image in which the image can be recognized earlier than the full frame period can be acquired.

In contrast, a peripheral range away from the vicinity of the optical axis is sufficient if it is imaged in the accumulation period of the full frame period, particularly when vehicle's turning to the right or left. Therefore, these regions are set as the second pixel region serving as a region of non-interest, and an image in the full frame period is acquired, whereby the data amount of the captured image can be reduced.

Thus, in the sixth embodiment, the first pixel region and the second pixel region are appropriately set based on the projection characteristics of the optical system 611 of the photoelectric conversion device 610, and image capturing is performed in different accumulation periods in each of the regions. As a result, an image can be recognized more quickly than the full frame period, the S/N ratio can be further increased, and the amount of data and power consumption can be reduced while reducing the blurring of pixels due to motion.

Note that, in the above-described embodiments, the example in which a region of interest and a region of non-interest are set according to the optical characteristics of the optical system 601 and the optical system 611 has been explained. However, in these embodiments, for example, the ranges of the region of interest and the region of non-interest may be changed according to the speed of the movable apparatus 700. This is because it is preferable that the range for evaluating the collision risk different is set to be different depending on the speed of the movable apparatus and the like.

Specifically, the region of interest and the region of non-interest may be switched according to the environment information including the information on the movable apparatus 700 obtained from the movable apparatus control unit (ECU). Alternatively, the region of interest may be enlarged or reduced according to the environment information including the information on the movable apparatus 700.

That is, as described above, the positions, switching, and sizes of the region of interest and the region of non-interest are changed according to the output and the like of the detection unit 602 and the like. Note that at least one of the position and size of the first pixel region and the second pixel region may be set by a user.

Note that the information on the movable apparatus that is one of the environmental information includes at least one of vehicle speed information, acceleration information, steering wheel angle information, brake information, and engine information. Additionally, the environment information also includes at least one of the presence or absence, position, speed, acceleration, and distance of traffic participants (pedestrians, motorcycles, bicycles, and the like around the movable apparatus), map information, GPS information, road conditions, road surface conditions, weather information, ambient luminance, time, and the like.

Thus, the control unit may set the first pixel region or the second pixel region based on at least one of characteristic information related to a characteristic of the photoelectric conversion device, installation information related to an installation state of the photoelectric conversion device, and environmental information related to the peripheral environment of the photoelectric conversion device. Furthermore, at least one of the position, size, and accumulation period of the first pixel region or the second pixel region may be set based on at least one of the characteristic information, the installation information, and the environment information. Additionally, the first pixel region or the second pixel region may be set according to the distance information of the object.

Note that the characteristic information includes optical characteristic information of the optical system, resolution of the sensor unit, and a pixel size of the sensor unit. Additionally, the installation information includes at least one of a height, an angle, and a direction in which the photoelectric conversion device is installed.

For example, as the speed of the movable apparatus 700 increases, the region of interest is set to the front and the region of interest in front is enlarged, and thereby, it is possible to further reduce the collision risk. Additionally, for example, in a case where the vehicle is traveling at a high speed on an expressway and the like, the risk of collision due to rushing out from the side is reduced, and thus, the region of interest on the side may be reduced.

Additionally, the region of interest and the region of non-interest may be switched according to whether the vehicle is traveling straight or turning to the right or left. For example, when the vehicle is traveling straight, the region around the traveling direction may be set as the region of interest. When the vehicle is turning right or left, a side in the turning direction may be set as the region of interest so that the risk of collision due to a left-turn or right-turn accident is reduced. That is, the control unit may set the first pixel region or the second pixel region based on the output of the ECU serving as a moving control unit.

Thus, also in the sixth embodiment, the control unit performs control so that the accumulation period in one of the first pixel region and the second pixel region becomes one of the first accumulation period and the second accumulation period. Note that the first pixel region may be controlled to have at least a first accumulation period and a second accumulation period. Additionally, the second pixel region may be controlled to have at least a first accumulation period and a second accumulation period.

### Seventh Embodiment

The seventh embodiment will be explained. In the seventh embodiment, the photoelectric conversion device 600 using the optical system 601, in which the reference numeral 601a denotes a high resolution region and the reference numeral 601b denotes a low resolution region, is mounted to a production line or an inspection line as a process confirmation or inspection camera in a factory and the like.

Additionally, in order to evaluate whether or not a target component, unit, and the like are correctly manufactured when manufacturing or inspection is performed, the photoelectric conversion apparatus 600 is installed so that the target component, unit, and the like flow in a range in the vicinity of the optical axis. Therefore, the range in the vicinity of the optical axis is set as a high resolution region, and the peripheral range away from the vicinity of the optical axis is set as a low resolution region.

For example, installation is performed such that a target component, unit, and the like can be evaluated in the vicinity of the optical axis, and it is possible to capture an image more accurately. In contrast, an image of a worker and the like performing work is captured in the periphery away from the vicinity of the optical axis, it is possible to confirm the presence or absence of the worker, confirm the work state, and confirm the prevention of injury.

Additionally, in the seventh embodiment, the region in the vicinity of the optical axis is set as the region of interest in the first image region and an image in the accumulation period shorter than the full frame period is acquired. Accordingly, an image can be recognized earlier than a full frame period, and the S/N of an image of an object moving, for example, on a belt conveyor can be increased, and an image with less blurring due to motion can be acquired.

In contrast, in the peripheral range away from the vicinity of the optical axis, it suffices if image capturing for confirmation of the presence or absence of a worker, confirmation of a work state, prevention of injury, and the like is performed. Therefore, these regions are set as the second pixel region serving as a region of non-interest, and an image in the full frame period is acquired, whereby the data amount of the captured image can be reduced.

Thus, the first pixel region and the second pixel region are appropriately set based on the projection characteristics of the optical system 601 of the photoelectric conversion device 600, and image capturing is performed in different accumulation periods in each of the regions. As a result, an image can be recognized earlier than the full frame period, the S/N ratio can be increased, and the amount of data and power consumption can be reduced while reducing the blurring of pixels due to motion.

### Eighth Embodiment

The eighth embodiment will be explained. In the eighth embodiment, the photoelectric conversion device 600 using the optical system 601 in which the reference numeral 601a denotes a high resolution region and the reference numeral 601b denotes a low resolution region is installed in a distribution line as a camera for distribution.

A label of a load and the like flowing in the line needs to be read and determined. In this situation, there is a case where the camera for distribution is required to perform three evaluations such as the grasp of the presence or absence of a load, the grasp of a label position, and reading of a label.

However, a camera for distribution that satisfies these requirements at the same time is required to have high performance, and therefore the camera becomes expensive. Accordingly, in the eighth embodiment, the photoelectric conversion device 600 using the optical system 601 is used as a camera for distribution.

For example, the presence or absence of a load and the label position are grasped in a peripheral range away from the vicinity of the optical axis, and the label is read in a range in the vicinity of the optical axis. Specifically, a range in the vicinity of the optical axis in which the label is read is set as a high resolution region, and a peripheral range away from the vicinity of the optical axis in which the presence or absence of the load and the label position are grasped is set as a low resolution region.

In the eighth embodiment, since it is required to quickly recognize when and what kind of shape an object flows in a peripheral range away from the vicinity of the optical axis where the presence or absence of a load and the label position are grasped, an image in an accumulation period shorter than the full frame period is acquired. As a result, an image can be recognized earlier than the full frame period.

In contrast, the range in the vicinity of the optical axis where reading of the label is performed is set as the second pixel region serving as a region of non-interest, and an image in the full frame period is acquired, whereby the data amount of the captured image can be reduced.

Thus, the first pixel region and the second pixel region are appropriately set based on the projection characteristics of the optical system 601 of the photoelectric conversion device 600, and image capturing is performed in different accumulation periods in each of the regions, whereby an image can be recognized earlier than a full frame period. Furthermore, it is possible to reduce an amount of data and power consumption while increasing the S/N ratio and reducing the blurring of pixels due to motion.

### Ninth Embodiment

Next, the ninth embodiment will be explained. In the ninth embodiment, the photoelectric conversion device 610 using the optical system 611 in which the reference numeral 611a denotes a low resolution region and the reference numeral 611b denotes a high resolution region is used as a monitoring camera.

In order to evaluate whether or not a suspicious person or a suspicious object enters a building or a specific range, a camera is installed so as to be able to capture an image of a monitoring range. Therefore, a range in the vicinity of the optical axis, which is the center of the monitoring range, is set as a low resolution region, and a peripheral range away from the vicinity of the optical axis, which is the periphery of the monitoring range, is set as a high resolution region. For example, it is important for a monitoring camera to immediately detect the intrusion of a suspicious person or suspicious object from outside the monitoring range, and it is important to be able to quickly capture an image of the peripheral region away from the optical axis and with high image quality.

Accordingly, in the ninth embodiment, the periphery away from the vicinity of the optical axis is set as the first pixel region serving as a region of interest, and an image in an accumulation period shorter than the full frame period is acquired in the first pixel region. Consequently, it is possible to obtain an image in which the image can be recognized earlier than the full frame period, the S/N of the movable apparatus is high, and blurring due to motion is small.

In contrast, although, in the range in the vicinity of the optical axis, it is necessary to monitor a suspicious person or suspicious object, it is often the case that it is more important to detect a suspicious person or suspicious object promptly at the time of intrusion of the suspicious person or suspicious object. Therefore, the data amount of the captured image can be reduced by setting the vicinity of the optical axis as the second pixel region serving as a region of non-interest, and acquiring the image in the full frame period.

Thus, the first pixel region and the second pixel region are appropriately set based on the projection characteristics of the optical system 611 of the photoelectric conversion device 610, and image capturing is performed in different accumulation periods in each of the regions, whereby an image can be recognized earlier than a full frame period. Furthermore, it is possible to reduce an amount of data and power consumption while increasing the S/N ratio and reducing the blurring of pixels due to motion.

### Tenth Embodiment

The tenth embodiment will be explained. In the tenth embodiment, the photoelectric conversion device 610 using the optical system 611 in which the reference numeral 611a denotes a low resolution region and the reference numeral 611b denotes a high resolution region is used as an agricultural camera.

The agricultural camera according to the tenth embodiment is used to grasp a state of crops. There are cases in which crops are cultivated in rows by making ridges. Therefore, since a single agricultural camera captures images of a plurality of rows, a peripheral range away from the vicinity of the optical axis of the imaging range is set as a high resolution region.

In contrast, for the purpose of preventing damage to the farm products by animals and the like, a range near the optical axis, which is the center of the monitoring range, corresponding to the space between the ridges of the farm products may be set as a low-resolution region. Additionally, since it is important to quickly detect the intrusion of animals and the like in order to prevent damage to farm products, it is necessary to be able to quickly capture an image of the vicinity of the optical axis.

Accordingly, in the tenth embodiment, the vicinity of the optical axis is set as the first pixel region serving as a region of interest, and an image is acquired in an accumulation period shorter than a full frame period in the first pixel region. Consequently, it is possible to recognize the image earlier than the full frame period.

In contrast, it is important to capture an image of the condition and growth of the farm products in the peripheral range away from the vicinity of the optical axis and make this a high resolution image, and this range is set as the second pixel region serving as a region of non-interest and an image is acquired in the full frame period. Consequently, it is possible to reduce the data amount of the captured image.

Thus, the first pixel region and the second pixel region are appropriately set based on the projection characteristics of the optical system 611 of the photoelectric conversion device 610, and image capturing is performed in different accumulation periods in each of the regions, whereby an image can be recognized earlier than a full frame period. Furthermore, it is possible to reduce the amount of data and power consumption.

### Eleventh Embodiment

FIG. 20 is a functional block diagram illustrating a configuration example of the photoelectric conversion device 600 and a movable apparatus 700 according to the eleventh embodiment. The photoelectric conversion device 600 of the eleventh embodiment is installed on the movable apparatus 700. Note that, in FIG. 20, the same reference numerals as those in FIG. 6 denote the same blocks, and the explanation will therefore be omitted.

In the eleventh embodiment, output of the image processing unit 603 is supplied to a recognition unit 604, the control unit 605, and an ECU (Electric Control Unit) 701 serving as a moving control unit of the movable apparatus 700. The recognition unit 604 recognizes a person, a vehicle, an object, and the like in the vicinity by performing image recognition based on the image signal, and outputs the recognition result to the ECU 701.

Additionally, the control unit 605 acquires information such as the installation height and the installation angle of the photoelectric conversion device 600 on the movable apparatus 700, which is installation information, from the ECU 701. Furthermore, the control unit 605 acquires the environmental information of the photoelectric conversion device 600 from the detection unit 602, and acquires the information of the movable apparatus 700 and the environmental information from the ECU 701.

The information on the movable apparatus acquired from the ECU 701 includes at least one of vehicle speed information, acceleration information, steering wheel operation angle information, brake information, and engine information. Additionally, the environment information includes at least one of the presence or absence, position, speed, acceleration, and distance of traffic participants (pedestrians, motorcycles, bicycles, and the like around the movable apparatus), map information, GPS information, road conditions, road surface conditions, weather information, ambient luminance, time, and the like.

In addition, The CPU executes a computer program stored in a memory built in the control unit 605 based on the acquired information in order to control each unit of the photoelectric conversion device 600.

The ECU 701 includes a CPU serving as a computer and a memory storing a computer program, and the CPU executes the computer program stored in the memory in order to control each unit of the movable apparatus 700.

The output of the ECU 701 is also supplied to a vehicle control unit 702 and the display unit 703. The vehicle control unit 702 functions as a travel control unit that performs operations such as driving, stopping, and direction control of the vehicle serving as a movable apparatus based on the output of the ECU 701.

Additionally, the display unit 703 includes a display element, for example, a liquid crystal device and an organic EL, and is installed on the movable apparatus 700. The display unit 703 displays an image acquired by the sensor unit and various types of information related to the traveling state of the vehicle for a driver of the movable apparatus 700 by using, for example, a GUI based on the output of the ECU 701.

Note that the image processing unit 603, the recognition unit 604, and the like in FIG. 20 need not be installed on the movable apparatus 700, and may be provided in, for example, an external terminal and the like which is provided separately from the movable apparatus 700 and used for remote control of the movable apparatus 700 or monitoring of the travelling of the movable apparatus.

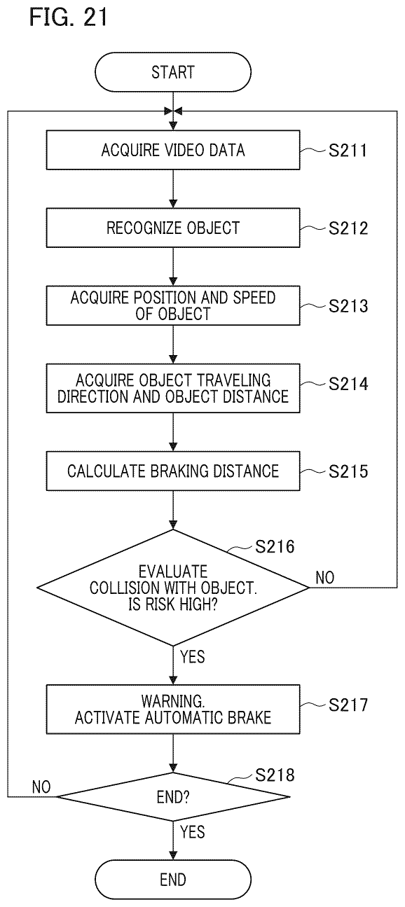

FIG. 21 is a flowchart that explains a control method of a movable apparatus according to the eleventh embodiment. Note that the operations of each step in the flowchart of FIG. 21 are sequentially performed by the control unit 605 and the CPU serving as a computer in the ECU 701 executing a computer program stored in the memory.

First, in step S211, the CPU of the control unit 605 acquires video data from the photoelectric conversion device 600 during operation. Next, in step S212, the CPU of the control unit 605 performs image recognition based on a signal that has been read out from the pixel region of the sensor unit 100 of the photoelectric conversion device 600, thereby recognizing the object.

Subsequently, in step S213, the CPU of the control unit 605 acquires the position and the speed of the recognized target object. The position and/or the speed of the recognized target object may be acquired by using a change of the object in the video data of a plurality of frames or using a millimeter wave radar or a light detection and ranging (LiDAR) serving as another ranging device.

Next, in step S214, the CPU of the ECU 701 acquires a traveling direction of the object and a distance to the object. As in the above case, the change of the object in the video data in a plurality of frames may be acquired by using a millimeter wave radar or a LiDAR serving as another ranging device.

Then, in step S215, the CPU of the ECU 701 calculates a braking distance of the own vehicle. Note that the braking distance changes depending on an inclination angle of the road surface, a condition of the road surface (such as asphalt, soil, gravel, rain, snow, and freezing), the wear of the tires (characteristics of the tires themselves, the distance of use, and the like), and the weight of the movable apparatus 700, in addition to the speed of the movable apparatus 700. Accordingly, the determination may be performed by comprehensively using the information.

Next, in step S216, the CPU of the ECU 701 performs evaluation of the risk of collision with the object. At this time, the evaluation is performed taking into consideration factors such as the speed, the traveling direction, and the distance of the object. Subsequently, in step S217, if the collision risk is high, the CPU of the ECU 701 generates a warning signal and gives a warning to the driver through the display unit 703 and a voice.

Furthermore, The automatic braking system is activated if necessary. Additionally, if it is determined in step S216 that the collision risk is not high, the process returns to step S211, and video data of the next frame is acquired.

Subsequent to step S217, the process proceeds to step S218, where the CPU of the ECU 701 determines whether or not the user has turned off the power supply of the movable apparatus, or whether or not an operation for ending the flow in FIG. 21 has been performed. If the determination result is “YES”, the flow of FIG. 21 ends. If the determination result in step S218 is “NO”, the process returns to step S211, and the operation of FIG. 21 is repeated.

### Twelfth Embodiment

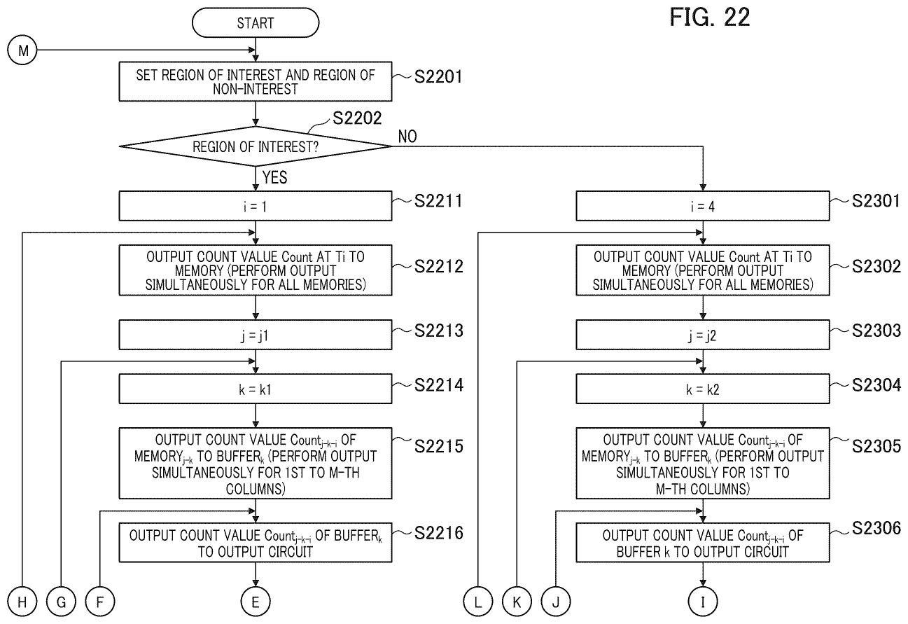

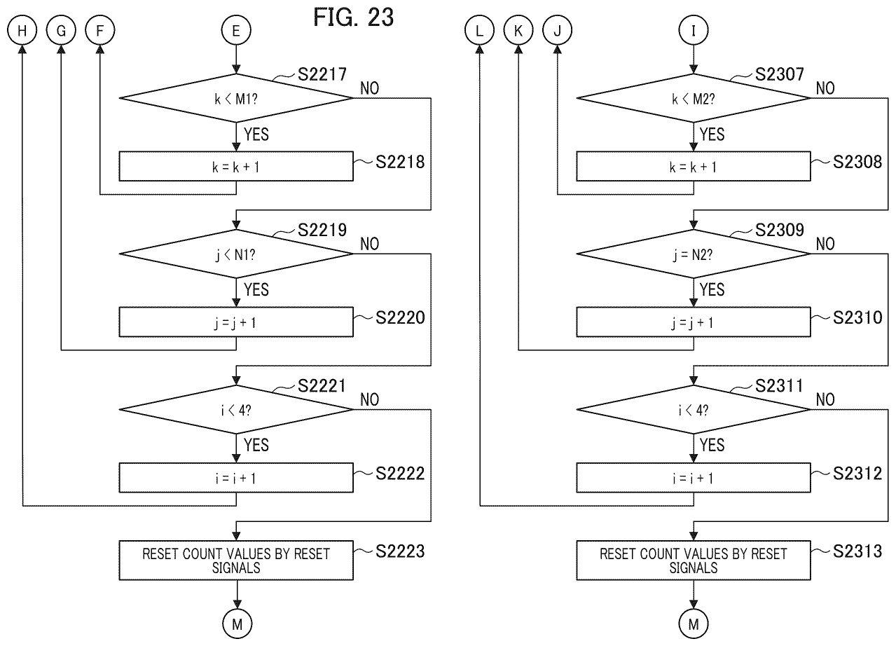

Next, FIG. 22 is a flowchart showing details of an example of driving of the sensor unit 100 related to a setting method of a region of interest according to the twelfth Embodiment, and FIG. 23 is a flowchart showing a continuation of FIG. 22. Note that the operations of each of the steps in the flowcharts of FIG. 22 and FIG. 23 are sequentially performed by the CPU serving as a computer in the control unit 605 executing a computer program stored in the memory.

In step S2201, the CPU of the control unit 605 of the photoelectric conversion device 600 sets a region of interest and a region of non-interest in the imaging region according to the optical characteristics of the optical system 601. In the present embodiment, a case where one region of interest and one non-region of interest are set individually will be explained. Note that, for the sake of description, the accumulation period of the first pixel region, which is a region of interest, is assumed to be a period divided into four periods of one full frame period, and the accumulation period of the second pixel region, which is a region of non-interest, is assumed to be one full frame period without being divided.

Here, the first pixel region starts from the pixel in the j1-th row and k1-th column and ends at the N1-th row and the M1-th column, and image capturing is executed in four different accumulation periods, whereas the second pixel region starts from the pixel in the j2-th row and the k2-th column and ends at the N2-th row and the M2-th column, and an image capturing is executed in one accumulation period.

Next, in step S2202, the CPU of the control unit determines whether or not the region is a region of interest. If the determination result is “YES”, the process proceeds to step S2211, and a process of determining the accumulation period is performed. In contrast, if the determination result in step S2202 is “NO”, the process proceeds to step S2301.

The region of interest is divided into four, and therefore i starts from 1 and is repeated up to 4. Accordingly, in step S2211, the CPU of the control unit first sets the value of i to 1. Next, in step S2212, the CPU of the control unit outputs the count value Count of the counter 211 at time T1 to the memory 212. At this time, the output is simultaneously performed for all the memories. This operation corresponds to the operation at time T1 in FIG. 7.

Next, in step S2213, the CPU of the control unit sets j=j1. j1 is the start position of the N-th row of the region of interest. Next, in step S2214, the CPU of the control unit sets k=k1. k1 is the start position of the M-th column of the region of interest.

In step S2215, the CPU of the control unit outputs the count value Count(j−k−i) in the memory j−k in FIG. 9 to the buffer. At this time, the outputs to the buffers are performed simultaneously for the first to M-th columns. This operation denotes an operation of taking the count value of the first row in FIG. 9 into the buffer.

In step S2216, the CPU of the control unit outputs the count value Count(j−k−i) of the buffer k to the output circuit 114. This operation corresponds to the operation of reading out the signals of the buffers in the leftmost column in FIG. 9 from the output circuit.

Next, the process proceeds to step S2217 in FIG. 23 via E, and, in step S2217, the CPU of the control unit determines whether or not k<M1, and if the determination result is “YES”, in step S2218, k=k+1 is set and k is incremented by 1, and the process returns to step S2216 via F. M1 is the end position of the M-th column of the region of interest. This operation corresponds to the operation of reading out the signal of the buffer in the second column from the left in FIG. 9 from the output circuit.

If the determination result in step S2217 is “NO”, that is, if k=M1 is obtained, it means that the signal of the buffer in the M1-th column in FIG. 9 has been read out from the output circuit, and next, the process proceeds to step S2219, where the CPU of the control unit determines whether or not j<N1. N1 is the end position of the N-th row of the region of interest. If the determination result in step S2219 is “YES”, in step S2220, the CPU of the control unit sets j=j+1 and increments j by 1, and the process returns to step S2214 via G. This corresponds to the operation for starting the readout of the next row.

If the determination result in step S2219 is “NO”, this means that the readout of all the rows has been completed, and the process proceeds to step S2221, where the CPU of the control unit determines whether or not j<4. If the determination result in step S2221 is “YES”, the CPU of the control unit sets i=i+1 and increments i by 1, and the process returns to step S2212 via H. This operation corresponds to the operation for starting the readout at the next time T2.

If the determination result in step S2221 is “NO”, it means that the readout at time T4 has been completed, and thus, the process proceeds to step S2223, where the CPU of the control unit resets the counter 211 with a reset signal. This operation corresponds to the reset operation of the counter 211 at time T4 in FIG. 7. After step S2223, the process returns to step S2201 via M. Thus, the signals accumulated in the sensor unit can be read out sequentially.

In contrast, since, in the region of non-interest, one full frame period is not divided, only the flow in the case where i is 4 is performed. Hence, in step S2301, the CPU of the control unit sets i=4. Next, in step S2302, the CPU of the control unit outputs the count value Count of the counter 211 at time Ti to the memory 212. At this time, the output is simultaneously performed for all the memories. This operation corresponds to the operation at time T1 in FIG. 7.

Next, in step S2303, the CPU of the control unit sets j=j2. j2 is the start position of the N-th row of the region of non-interest. Next, in step S2304, the CPU of the control unit sets k=k 2. k2 is the start position of the M-th column of the region of non-interest.

In step S2305, the CPU of the control unit outputs the count value Count (j−k−i) in the memory j−k in FIG. 9 to the buffer. At this time, the outputs to the buffers are performed simultaneously for the first to M-th columns. This operation means an operation of taking the count value of the first row in FIG. 9 into the buffer.

In step S2306, the CPU of the control unit outputs the count value Count (j−k−i) of the buffer k to the output circuit 114. This operation corresponds to the operation of reading out the signals of the buffers in the leftmost column in FIG. 9 from the output circuit.

Next, the process proceeds to step S2307 in FIG. 23 via I, and in step S2307, the CPU of the control unit determines whether or not k<M2. If the determination result in step S2307 is “YES”, in step S2308, the CPU of the control unit sets k=k+1 and increments k by 1, and the process returns to step S2306 via J. M2 is the end position of the M-th column of the region of non-interest. This operation corresponds to the operation of reading out the signal of the buffer in the second column from the left in FIG. 9 from the output circuit.

If the determination result in step S2307 is “NO”, that is, if k=M 2, it means that the signal of the buffer in the M2-th column in FIG. 9 has been completely read out from the output circuit, and the process proceeds to step S2309, where the CPU of the control unit determines whether or not j<N2.

N2 is the end position of the N-th row of the region of non-interest. If the determination result in step S2309 is “YES”, in a step S2310, the CPU of the control unit sets j=J+1 and increments j by 1, the process returns to the step S2304 via K. This corresponds to the operation for starting the readout of the next row.

If the determination result in step S2309 is “NO”, this means that the readout of all the rows has been completed, and the process proceeds to step S2311, where the CPU of the control unit determines whether or not j<4. If the determination result in step S2311 is “YES”, the CPU of the control unit sets i=i+1 and increments i by 1, and the process returns to step S2302 via L. This operation corresponds to the operation for starting the readout at the next time T2. However, since i=4 is set in step S2301, the determination result in step S2311 is “NO”.

If the determination result in step S2311 is “NO”, this means that the readout at time T4 has been completed, and thus, the process proceeds to step S2313, where the CPU of the control unit resets the counter 211 with a reset signal. This operation corresponds to the reset operation of the counter 211 at time T4 in FIG. 7. After step S2313, the process returns to step S2201 via M. Thus, the signals accumulated in the sensor unit can be read out sequentially.

Therefore, the region of interest starts from the pixel of j1 row and k1 column and repeats up to N1 row and M1 column, and the image capturing in four different accumulation periods is executed, while in contrast, the region of non-interest starts from the pixel of j2 row and k2 column and repeats up to N2 row and M2 column, and only the image capturing in one accumulation period is executed.

Next, processing of images acquired in each of the region of interest and the region of non-interest in the photoelectric conversion device 600 will be explained. The acquisition method of the image in the region of interest is performed based on the method as shown in FIG. 22 and FIG. 23. Additionally, in the region of interest, an image is acquired in four accumulation periods of the frame 1_1, the frame 1_2, the frame 1_3, and the frame 1_4 in FIG. 7. In contrast, in the region of non-interest, an image is acquired in the accumulation period of only the frame 1_4 in FIG. 7.

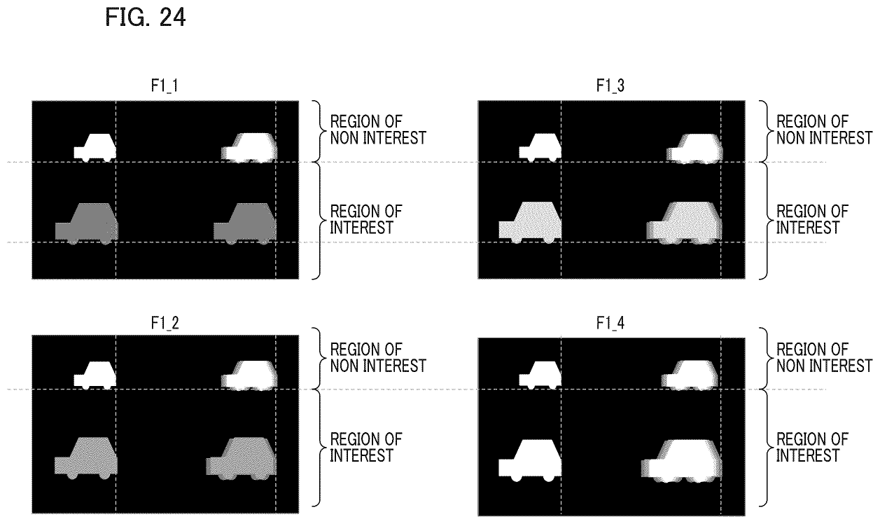

FIG. 24 shows an example of an image generated according to the flow of FIG. 22 and FIG. 23. FIG. 24 is a diagram showing an example of an image for each of a plurality of accumulation periods and setting a region of interest. In each drawing, a range in which a short distance on the lower side is imaged is set as a region of interest, a range in which a long distance on the upper side is imaged is set as a region of non-interest, a vehicle on the left side stops, and a vehicle on the right side is traveling from right to left at a certain speed.

As shown in FIG. 24, the regions on the lower side of the screen, which are the regions of interest, are updated in four stages from frame 1_1 to frame 1_4. Accordingly, in the case of the vehicle in a stop state, the luminance of the image gradually increases as the accumulation period increases from frame 1_1 to 1_4. Additionally, in the case of a moving vehicle, a shaking occurs in the forward and backward directions of the traveling direction as the accumulation period becomes longer, as in frames 1_1 to 1_4, and the luminance of the overlapping portion of the motion becomes high.

In contrast, the region on the upper side of the screen, which is a region of non-interest, is updated only by the output of the frame 1_4. Therefore, since, in the case of the vehicle in a stop state, update is performed every full frame period and image capture is performed in the accumulation period of the full frame period, the image in which the luminance is high is obtained. Similarly, in the case of a moving vehicle, since update is performed every full frame period and the image capture is performed in the accumulation period of the full frame period, blurring occurs in the forward and backward of the traveling direction, and the luminance of a portion where the motion overlaps become high.

Accordingly, in the region of non-interest, all of the images of the frame 1_1 to the frame 1_3 are images captured in the accumulation period of the frame 1_4 in the previous full frame period. Additionally, in the frame 1_4, the image is updated to the image captured in the accumulation period of the frame 1_4 in the current full frame period.

By following the flow of FIG. 22 and FIG. 23, the region of interest is updated four times in the full frame period, so that an image can be acquired in a time shorter than the full frame period, and faster recognition can be performed. In contrast, in the region of non-interest, update is performed only once in the full frame period, and thereby, the data amount can be reduced and the power consumption can be reduced.

The processing in a subsequent stage is performed according to the characteristics of the photoelectric conversion device 600 based on the image data created according to the flowcharts of FIG. 22 and FIG. 23.

For example, in the case of a security camera, behavior monitoring, imaging, and recording of a target person is performed by the control unit 605. In some cases, the warning can be displayed, the light provided in the security camera can be turned on, and the generation of warning sound can be performed through the communication unit 607.

In addition, in the case of an in-vehicle camera and the like, a display of attention calling or warning is performed by the control unit 605 via the ECU, and an operation of a safety device for decelerating and stopping the vehicle and the like is performed by the vehicle control unit 702, so that it is possible to reduce or avoid a collision.

In addition, for example, as a camera, it is possible to acquire an image in an appropriate accumulation period when inside the image capturing region by recognizing a person or a registered face. Additionally, as a pet camera, it is possible to recognize a pet and remotely confirm the state of the pet and capture an image of the pet.

Additionally, in a case where the camera is used as a monitoring camera, a specific place and region can be set as a region of interest so that the state is grasped, an illegal act is monitored and prevented, and an evidence is collected as a record at a place where safety management or monitoring is necessary (for example, parking place, public facility, factory, and the like). Consequently, it is possible to monitor the region of interest at a higher frequency and record and display video and audio.

Additionally, in a case where the camera is used as a camera for detecting defects in a factory, the camera can be used to assist quality control and efficiency of a manufacturing process, to detect and eliminate defective products at an early stage, to troubleshoot a production line, and to improve the quality of a product. In this case, it is possible to detect and record the defect and abnormality of the product with higher accuracy in a manufacturing line of a factory and a workplace.

Additionally, in a case where the camera is used as a packaging inspection camera in a factory, it is possible to inspect the packaging state of a product, the accuracy of a label, and a defect in order to strengthen the quality control of the product and ensure the integrity of the packaging and the accuracy of the label.

In a case where the camera is used as a camera for distribution, the efficiency and accuracy of distribution work can be improved in distribution warehouse, distribution centers, and the like, and appropriate product management and quick distribution processes can be realized. Then, the shape, size, bar code, and the like of the product and package are recognized, and accurate sorting and distribution processing can be performed.

In a case where the camera is used as an endoscopic camera, it is possible to obtain video images of the inside of a body and an organ with high quality by a camera incorporated in an endoscope used in the medical field in order to more accurately observe the state of the inside of the body in endoscopic surgery and diagnosis and support the diagnosis of diseases and planning of treatment.

In a case where the camera is used as a nursing care needing state detection camera, it is possible to monitor the living state of an elderly person and a person in need of nursing care and detect an abnormality and a dangerous state in order to perform early detection and support of a fall, an abnormal behavior, and an emergency situation, for the purpose of safety and life support of a person in need of nursing care.

In a case where the camera is used as an infrastructure monitoring camera, it is possible to detect anomalies, damage and unauthorized activity in order to monitor infrastructure such as roads, bridges, railways and power plants, to maintain safety and reliability, and to perform early warning and appropriate maintenance.

Additionally, in a case where the camera is used as an infrastructure monitoring camera, it is possible to monitor public places and facilities and a specific area and perform prevention, monitoring, and recording of illegal acts and criminal acts in order to ensure the public safety, crime prevention, prevention of illegal acts, collect evidence for criminal investigations, and the like.

Additionally, in a case where the camera is used as an agricultural camera, it is possible to support appropriate cultivation management, early detection of pests, and effective agricultural measures in order to improve productivity and quality of farm products. In this case, it is possible to monitor the growth state of farm products and the occurrence of pests, and provide video data useful for agricultural production management.

### Thirteenth Embodiment

Next, the thirteenth embodiment will be explained. In the thirteenth embodiment, a method of setting the accumulation period of the region of interest according to the brightness and the like of the region of interest will be explained.

It has been explained that, in a monitoring camera and an in-vehicle camera mounted on a movable apparatus, it is effective to acquire an image of an object at a short distance and an image of an object on a side surface of the movable apparatus as an image with a short accumulation period at an early timing. However, it is known that, in contrast, if the accumulation period is short, the ratio of noise in the signal component increases, and what is referred to as S/N ratio deteriorates.

This is particularly conspicuous in a case where a dark region is imaged. Therefore, even if an image is obtained by shortening the accumulation period in a case where the region of interest is dark, the image has a poor S/N ratio, and it is difficult to use the image for appropriate display and subsequent processing.

Therefore, there is a drawback in which an appropriate determination cannot be performed or power consumption of the device increases due to the execution of unnecessary processing. Therefore, in the thirteenth embodiment, a method for capturing an image with a high S/N ratio by adjusting the accumulation period according to the brightness of the region of interest will be explained.

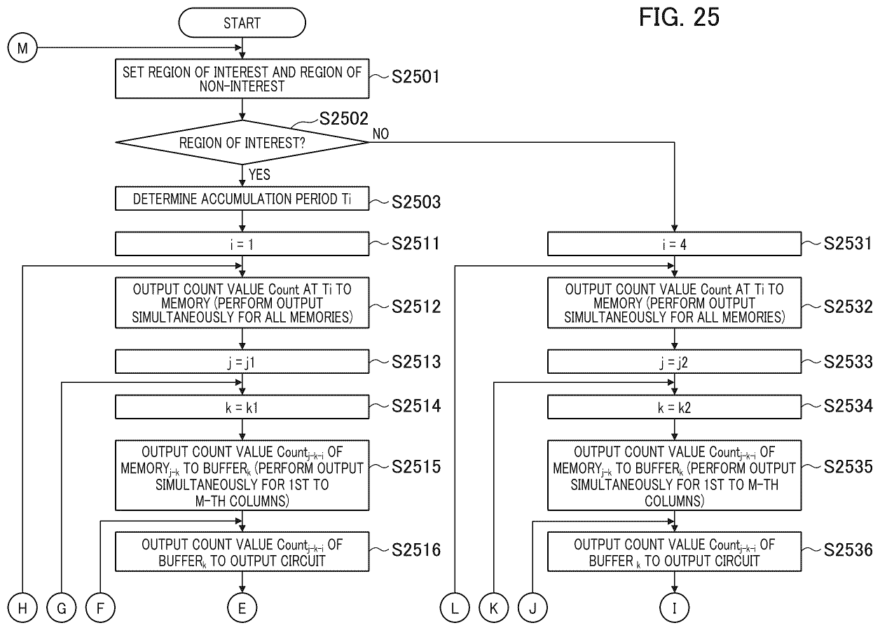

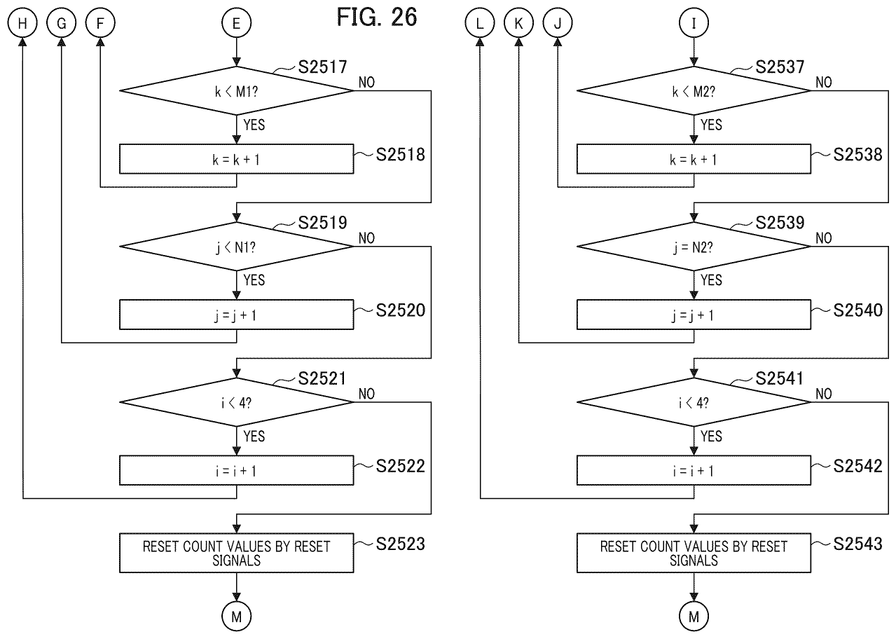

In the thirteenth embodiment, FIG. 25 is a flowchart showing details of an example in which the sensor unit 100 is driven by setting an accumulation period, and FIG. 26 is a flowchart showing a continuation of FIG. 25. Note that the operations of each of steps in the flowcharts of FIG. 25 and FIG. 26 are sequentially performed by the CPU serving as a computer in the control unit 605 executing a computer program stored in the memory.

First, in step S2501, the CPU of the control unit sets a region of interest. As in the embodiments as described above, the region of interest is set based on at least one of the product information, the installation information, and the environment information of the photoelectric conversion device 600 recorded in the control unit 605 of the photoelectric conversion device 600.

Next, in step S2502, the CPU of the control unit determines whether the region is a region of interest or a region of non-interest. In the region of interest, the process proceeds to step S2511 in FIG. 19, and the CPU of the control unit performs the processing of determining the accumulation period. In contrast, in the region of non-interest, the process proceeds to step S2531.

Next, in step S2503, the CPU of the control unit determines the accumulation period of the region of interest. In the present embodiment, for example, an average luminance value of an image acquired in the previous frame in the region of interest is calculated by the control unit 605, and a Look Up Table (LUT) and a calculation formula of an accumulation period corresponding to the luminance value is stored in the memory of the control unit 605, and the accumulation period is obtained by using it.

Thus, in the present embodiment, the length of at least one of the first accumulation period and the second accumulation period is set based on the luminance information of the signal generated in at least one of the first accumulation period and the second accumulation period.

Note that in addition to the average luminance, the luminance value may be obtained based on the peak of the histogram, the bias of the peak, the spread, and the dispersion. Additionally, a luminance difference from an adjacent pixel in the screen may be obtained, a noise amount may be calculated based on a histogram of the difference, and the accumulation period may be obtained from the result. Further, the accumulation period may be calculated based on average value and the like of a plurality of previous frames, in addition to the previous frame, or may be obtained from an average luminance of each accumulation period in the frame, a histogram, and the like.

Although, in the present embodiment, the flowchart in the case where the number of accumulation periods is four is shown in FIG. 25 and FIG. 26, the number of accumulation periods is not limited to four, and may be one, three, or four or more. Then, in step S25011, the CPU of the control unit sets the obtained accumulation period (Ti).

In step S2511 of FIG. 25, the CPU of the control unit sets i=1. Next, in step S2512, the CPU of the control unit outputs the count value Count of the counter 211 at time Ti to the memory 212. At this time, the output is simultaneously performed for all the memories. This operation corresponds to the operation at time T1 in FIG. 7.

Next, in step S2513, the CPU of the control unit sets j=j1. j1 is the start position of the N-th row of the region of interest. Next, in step S2514, the CPU of the control unit sets k=k1. k1 is the start position of the M-th column of the region of interest.

In step S2515, the CPU of the control unit outputs the count value Count (j−k−i) in the memory j−k in FIG. 9 to the buffer. At this time, the outputs to the buffers are performed simultaneously for the first to M-th columns. This operation denotes an operation of incorporating the count value of the first row in FIG. 9 into the buffer.

In step S2516, the CPU of the control unit outputs the count value Count (j−k−i) of the buffer k to the output circuit 114. This operation corresponds to the operation of reading out the signals of the buffers in the leftmost column in FIG. 9 from the output circuit.

Next, the process proceeds to step S2517 in FIG. 26 via E, and in step S2517, the CPU of the control unit determines whether or not k<M1, and if the determination result is “YES”, in step S2518, the CPU of the control unit sets k=k+1 and increments k by 1, and the process returns to step S2516 via F. M1 is the end position of the M-th column of the region of interest. This operation corresponds to the operation of reading out the signal of the buffer in the second column from the left in FIG. 9 from the output circuit.

If the determination result in step S2517 is “NO”, that is, if k=M 1, it means that the signal of the buffer in the M-th column in FIG. 9 has already been read out from the output circuit, and next, the process proceeds to step S2519, where the CPU of the control unit determines whether or not j<N1.

N1 is the end position of the N-th row of the region of interest. If the determination result in step S2519 is “YES”, in a step S2520, the CPU of the control unit sets j=j+1 and increments j by 1, the process returns to the step S2514 via G. This corresponds to the operation for starting the readout of the next row.

If the determination result in step S2519 is “NO”, this means that the readout of all the rows has been completed, and thus the process proceeds to step S2521, where the CPU of the control unit determines whether or not i<4. If the determination result in step S2521 is “YES”, the CPU of the control unit sets i=i+1 and increments i by 1, and the process returns to step S2512 via H. This operation corresponds to the operation for starting the readout at the next time T2.

If the determination result in step S2521 is “NO”, it means that the readout at time T4 has been completed, and thus the process proceeds to step S2523, where the CPU of the control unit resets the counter 211 with a reset signal.

This operation corresponds to the reset operation of the counter 211 at time T4 in FIG. 7. After step S2313, the process returns to step S2501 via M. Thereby, the signals accumulated in the sensor unit can be read out sequentially.

In contrast, since the accumulation period of the region of non-interest is equal to the full-frame period, an image is acquired in a predetermined accumulation period. That is, in step S2531 of FIG. 25, the CPU of the control unit sets i=4. Next, in step S2532, the CPU of the control unit outputs the count value Count of the counter 211 at time Ti to the memory 212. At this time, the output is simultaneously performed for all the memories. This operation corresponds to the operation at time T1 in FIG. 7.

Next, in step S2533, the CPU of the control unit sets j=j2. j2 is the start position of the N-th row of the region of non-interest. Next, in step S2534, the CPU of the control unit sets k=k2. k2 is the start position of the M-th column of the region of non-interest.

In step S2535, the CPU of the control unit outputs the count value Count (j−k−i) in the memory j−k in FIG. 9 to the buffer. At this time, the outputs to the buffers are performed simultaneously for the first to M-th columns. This operation means an operation of bringing the count value of the first row in FIG. 9 into the buffer.

In step S2536, the CPU of the control unit outputs the count value Count (j−k−i) of the buffer k to the output circuit 114. This operation corresponds to the operation of reading out the signals of the buffers in the leftmost column in FIG. 9 from the output circuit.

Next, the process proceeds to step S2537 in FIG. 26 via I, and in step S2537, the CPU of the control unit determines whether or not k<M2, and if the determination result is “YES”, in S2538, the CPU of the control unit sets k=k+1 and increases k by 1, and the process returns to step S2536 via J. M2 is the end position of the M-th column of the region of non-interest. This operation corresponds to the operation of reading out the signal of the buffer in the second column from the left in FIG. 9 from the output circuit.

If the determination result in step S2537 is “NO”, that is, if k=M2, it means that the signal of the buffer in the M-th column in FIG. 9 has already been read out from the output circuit, and the process proceeds to step S2539, where the CPU of the control unit determines whether or not j<N2.

N2 is the end position of the N-th row of the region of interest. If the determination result in step S2539 is “YES”, in step S2540, the CPU of the control unit sets j=J+1 and increments j by 1, the process returns to the step S2544 via K. This corresponds to the operation for starting the readout of the next row.

If the determination result in step S2539 is “NO”, this means that the readout of all the rows has been completed, and thus, the process proceeds to step S2541, where the CPU of the control unit determines whether or not i<4. If the determination result in step S2541 is “YES”, the CPU of the control unit sets i=i+1 and increments i by 1, and the process returns to step S2532 via L. This operation corresponds to the operation for starting the readout at the next time T2. However, since i=4 is set in step S2531, the determination result in step S2541 is “NO”.

If the determination result in step S2541 is “NO”, it means that the readout at time T4 has been completed, and thus the process proceeds to step S2543, where the CPU of the control unit resets the counter 211 with a reset signal. This operation corresponds to the reset operation of the counter 211 at time T4 in FIG. 7. After step S2543, the process returns to step S2501 via M.

Thus, the signals accumulated in the sensor unit can be read out sequentially. Note that, also in the region of non-interest, an image may be similarly acquired in the accumulation period that has been determined by the control unit 605. In this case, a flow for setting the accumulation period is added before an image is acquired.

Although, in the above-described embodiment, for example, accumulation is performed for a period of ¼ full frame at the shortest, the length of the shortest accumulation period may be changed, for example, to ⅕ full frame period or ⅓ full frame period depending on the recognition accuracy of the recognition unit 604. Alternatively, the length of the shortest accumulation period may be changed according to the brightness of the object. In addition, the recognition unit may also further recognize an object based on a signal generated in the second accumulation period.

Furthermore, even in a case where the readout cycle is set to ¼ of the full frame period, the counter may be reset during the accumulation period of frame 1_1 in FIG. 7 according to the brightness of the object, the image recognition accuracy, and the like. Thereby, the substantial accumulation period may be shorter than ¼ full frame period.

Alternatively, the counter may be reset at, for example, time T1 in FIG. 7. Thereby, the count value read out at time T4 may be adjusted. Note that although, in the above embodiments, the accumulation period is set at equal intervals, the present invention is not limited thereto.

Additionally, in the above-described embodiments, an example has been explained in which various processing is performed based on the captured image data by using various cameras, devices provided in the cameras, personal computers, and the like.

For example, in the case of a security camera, behavior monitoring, imaging, and recording of a target person is performed by the control unit 605. In some cases, display of a warning, irradiation of a light provided in the security camera, generation of a warning sound, and the like are performed via the communication unit 607. Additionally, in the case of an in-vehicle camera and the like, a display of attention calling or warning is performed by the control unit 605 via the ECU 701, and an operation of a safety device for decelerating and stopping the vehicle is performed by the vehicle control unit 702.

### Fourteenth Embodiment

In the fourteenth embodiment, before performing various processing, the control unit 605 determines whether not an image acquired by the photoelectric conversion device 600 is suitable for performing the subsequent processing. As a result, it is possible to further reduce the load on the processing and realize a reduction in the processing load, a reduction in the power consumption, and the like. Furthermore, it is possible to avoid an erroneous determination, an erroneous warning by the security camera, an erroneous operation of the safety device by the on-vehicle camera, and the like due to an inappropriate image.

In the fourteenth embodiment, the captured image data are evaluated by the control unit 605. Then, it is determined whether or not the image is appropriate or not by using the average luminance value of the output of each frame, and if the image is appropriate, it is determined whether or not the image is to be used for the next process.

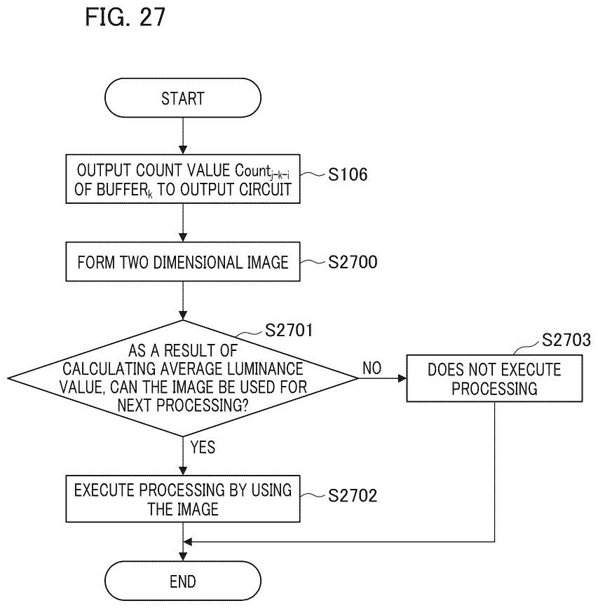

FIG. 27 is a flowchart illustrating an example of operation of the control unit after an image is constituted according to the fourteenth embodiment. Note that the operations of each of the steps in the flowchart of FIG. 27 are sequentially performed by the CPU serving as a computer in the control unit 605 executing a computer program stored in the memory.

As the flow until an image is acquired, for example, the example shown in FIG. 22 and FIG. 23 is used. First, in step S2700, the CPU of the control unit constitutes an image using the count value that has been output in step S106 of FIG. 22.

Then, in step S2701, the CPU of the control unit determines whether or not the image is appropriate for use in the next process. Here, the inappropriate image refers to an image that has a poor S/N ratio and is affected by noise and an image that is too dark to be recognized.

As the determination method in step S2701, it is possible to determine based on the average brightness of the acquired image. That is, the value of the average luminance is calculated by the control unit 605, and it is determined whether or not the image can be used for the next process according to the calculated value. Specifically, the control unit controls whether or not to perform the predetermined processing in the control unit, according to luminance information of a signal generated in at least one of the first accumulation period and the second accumulation period.

Additionally, the luminance value may be obtained based on the peak of the histogram, the bias of the peak, the spread, and the dispersion, in addition to the average luminance. Additionally, a luminance difference from an adjacent pixel in the screen may be obtained, a noise amount may be calculated based on a histogram of the difference, and it may be determined from the result whether or not the image can be used for the next processing.

Furthermore, the determination is not limited to the previous full frame period, and may be performed based on an average value of a plurality of previous full frames, or may be performed based on, for example, an average luminance, and a histogram of each accumulation period in the full frame. If it is determined in step S2701 that the image is an appropriate image, next, in step S2702, the CPU of the control unit executes processing using a computer program and the like of the control unit 605.

In contrast, if the image is determined to be inappropriate, in step S2703, the CPU of the control unit does not perform processing using the computer program of the control unit 605, and stops processing using the computer program until an image of the next accumulation period is obtained.

By performing the flow as shown in FIG. 25, it is possible to reduce the number of times of performing unnecessary processing in the control unit 605, and it is possible to reduce the product power. Additionally, it is possible to avoid an erroneous determination, an erroneous warning by the security camera, an erroneous operation of the safety device by the on-vehicle camera, and the like due to an inappropriate image.

Note that although, in the above-described embodiments, the movable apparatus 700 has been described using an example of an automobile, the movable apparatus may be any movable apparatus such as an aircraft, a train, a ship, a drone, an AGV, and a robot.

Additionally, the photoelectric conversion device 600 of the present embodiment may be mounted on a wall or a pillar, in addition to the movable apparatus. In this context, it is desirable that the installation height, the installation angle, and the like are held in the storage unit 606 and the like, as installation information when the photoelectric conversion device 600 is mounted on a wall, a pillar, and the like.

Although the present invention has been described in detail based on the preferred embodiments thereof, the present invention is not limited to the above-described plurality of embodiments, and various modifications can be made based on the gist of the present invention, which are not excluded from the scope of the present invention. Note that the present invention also includes a combination of the above-described embodiments, and includes the following configurations, methods, and the like.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to a photoelectric conversion device and the like through a network or various storage media. Then, a computer (or a CPU, an MPU, or the like) of the photoelectric conversion device and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2023-139711, filed on Aug. 30, 2023, which is hereby incorporated by reference herein in its entirety

What is claimed is:

1. A photoelectric conversion device comprising:
a plurality of pixels each including a photoelectric conversion unit configured to emit pulses in response to photons, a counter configured to count the number of the pulses, and a memory configured to store a count value of the counter;
an optical system configured to form an object image having different resolutions in a first pixel region and a second pixel region of a sensor unit consisting of the plurality of pixels;
one or more memories storing instructions; and
one or more processors executing the instructions to:
generate a signal based on a difference between count values of the counter at a start time and an end time of an accumulation period;
perform control such that a signal generated in a first accumulation period is output between the end of the first accumulation period and the end of a second accumulation period, the first accumulation period and the second accumulation period that is longer than the first accumulation period being included in one full frame period; and
perform control such that an accumulation period of the first pixel region is set to the first accumulation period and an accumulation period of the second pixel region is set to the second accumulation period, or that an accumulation period of the first pixel region is set to the second accumulation period and an accumulation period of the second pixel region is set to the first accumulation period.

2. The photoelectric conversion device according to claim 1, wherein the one or more processors further executes instructions to control the first pixel region to have at least the first accumulation period and the second accumulation period.

3. The photoelectric conversion device according to claim 1, wherein the one or more processors further executes instructions to control the second pixel region to have at least the first accumulation period and the second accumulation period.

4. The photoelectric conversion device according to claim 1, wherein the one or more processors further executes instructions to make the first accumulation period and the second accumulation period overlap.

5. The photoelectric conversion device according to claim 1, wherein the one or more processors further executes instructions to start the first accumulation period and the second accumulation period at the same time.

6. The photoelectric conversion device according to claim 1, wherein an end time of the second accumulation period coincides with an end time of a full frame period.

7. The photoelectric conversion device according to claim 1, wherein the one or more processors further executes instructions to recognize an object based on a signal generated in at least the first accumulation period.

8. The photoelectric conversion device according to claim 7, wherein the one or more processors further executes instructions to further recognize the object based on a signal generated in the second accumulation period.

9. The photoelectric conversion device according to claim 1, further comprising a display unit configured to display a signal generated in the second accumulation period as an image.

10. The photoelectric conversion device according to claim 1, wherein the photoelectric conversion unit includes an avalanche photodiode.

11. The photoelectric conversion device according to claim 1, wherein the one or more processors further executes instructions to set the second pixel region on the center side of a light receiving surface of the sensor unit in a case where a resolution in the vicinity of the optical axis of the optical system is higher than a resolution on a peripheral side away from the optical axis.

12. The photoelectric conversion device according to claim 1, wherein the one or more processors further executes instructions to set the second pixel region on a peripheral side of a light receiving surface of the sensor unit in a case where a resolution on a peripheral side away from the optical axis of the optical system is higher than a resolution in the vicinity of the optical axis.

13. The photoelectric conversion device according to claim 1, wherein the one or more processors further executes instructions to set a pixel region having the relatively high resolution of a light receiving surface of the sensor unit in the second pixel region.

14. The photoelectric conversion device according to claim 1, wherein the second pixel region is provided inside the first pixel region.

15. The photoelectric conversion device according to claim 1, wherein the second pixel region is adjacent to the first pixel region.

16. The photoelectric conversion device according to claim 1, wherein at least one of a position and a size of the first pixel region and the second pixel region can be set by a user.

17. The photoelectric conversion device according to claim 1, wherein the one or more processors further executes instructions to set the first pixel region or the second pixel region based on at least one of characteristic information on a characteristic of the photoelectric conversion device, installation information on an installation state of the photoelectric conversion device, and environmental information on a surrounding environment of the photoelectric conversion device.

18. The photoelectric conversion device according to claim 17, wherein the one or more processors further executes instructions to set at least one of a position, a size, and an accumulation period of the first pixel region or the second pixel region based on at least one of the characteristic information, the installation information, and the environmental information.

19. The photoelectric conversion device according to claim 17, wherein the characteristic information includes optical characteristic information of the optical system, a resolution of the sensor unit, and a pixel size of the sensor unit.

20. The photoelectric conversion device according to claim 17, wherein the installation information includes at least one of a height, an angle, and a direction in which the photoelectric conversion device is installed.

21. The photoelectric conversion device according to claim 1, wherein the one or more processors further executes instructions to set the first pixel region or the second pixel region according to distance information of an object.

22. The photoelectric conversion device according to claim 1, wherein the one or more processors further executes instructions to set a length of at least one of the first accumulation period and the second accumulation period based on luminance information of a signal generated in at least one of the first accumulation period and the second accumulation period.

23. The photoelectric conversion device according to claim 1, wherein the one or more processors further executes instructions to control whether or not to perform predetermined processing in the control unit according to luminance information of a signal generated in at least one of the first accumulation period and the second accumulation period.

24. A movable apparatus comprising:
a photoelectric conversion device including a plurality of pixels each including a photoelectric conversion unit configured to emit pulses in response to photons, a counter configured to count the number of the pulses, and a memory configured to store a count value of the counter;
an optical system configured to form an object image having different resolutions in a first pixel region and a second pixel region of a sensor unit including the plurality of pixels;
one or more memories storing instructions; and
one or more processors executing the instructions to:
generate a signal based on a difference between count values of the counter at a start time and an end time of an accumulation period;
perform control such that a signal generated in a first accumulation period is output between the end of the first accumulation period and the end of a second accumulation period, the first accumulation period and the second accumulation period longer than the first accumulation period being included in one full frame period;
perform control such that an accumulation period of the first pixel region is set to the first accumulation period and an accumulation period of the second pixel region is set to the second accumulation period, or that an accumulation period of the first pixel region is set to the second accumulation period and an accumulation period of the second pixel region is set to the first accumulation period; and
set the first pixel region or the second pixel region based on an output of a movement control unit.

25. A control method for controlling a photoelectric conversion device including a plurality of pixels each including a photoelectric conversion unit configured to emit pulses in response to photons, a counter configured to count the number of the pulses, and a memory configured to store a count value of the counter, and an optical system configured to form object images having different resolutions in a first pixel region and a second pixel region of a sensor unit consisting of the plurality of pixels, the method comprising:
generating a signal based on a difference between count values of the counter at a start and an end of an accumulation period;
performing control such that a signal generated in a first accumulation period is output between the end of the first accumulation period and the end of a second accumulation period, the first accumulation period and the second accumulation period longer than the first accumulation period being included in one full frame period; and
performing control such that an accumulation period of the first pixel region is set to the first accumulation period and an accumulation period of the second pixel region is set to the second accumulation period, or that an accumulation period of the first pixel region is set to the second accumulation period and an accumulation period of the second pixel region is set to the first accumulation period.

26. A non-transitory computer-readable storage medium configured to store a computer program for a photoelectric conversion device including a plurality of pixels each including a photoelectric conversion unit configured to emit a pulse in response to incidence of photons, a counter configured to count the number of pulses, and a memory configured to store a count value of the counter, and an optical system configured to form object images having different resolutions in a first pixel region and a second pixel region of a sensor unit including the plurality of pixels,
wherein the computer program executes the following steps:
generating a signal based on a difference between count values of the counter at a start time and an end time of an accumulation period;
performing control such that a signal generated in a first accumulation period is output between the end of the first accumulation period and the end of a second accumulation period, the first accumulation period and the second accumulation period longer than the first accumulation period being included in one full frame period; and
performing control such that an accumulation period of the first pixel region is set to the first accumulation period and an accumulation period of the second pixel region is set to the second accumulation period, or that an accumulation period of the first pixel region is set to the second accumulation period and an accumulation period of the second pixel region is set to the first accumulation period.
